(19) United States
(12) Patent Application Publication
(10) Pub. No.: US 2026/0148037 A1
(43) Pub. Date: May 28, 2026

(54) METHOD AND SYSTEM FOR RESOURCE MANAGEMENT BY OPTIMIZING ACTIONABLE STRATEGIES

(71) Applicant: ACCENTURE GLOBAL SOLUTIONS LIMITED, Dublin 4 (IE)

(72) Inventors: Karthik RAJKUMAR KANNAN, Chennai (IN); Joshy RAVINDRAN, Bangalore (IN); Bipin Chandra PRABHA, Bangalore (IN); Ankit Singh BHADAURIA, Noida (IN)

(73) Assignee: ACCENTURE GLOBAL SOLUTIONS LIMITED, Dublin 4 (IE)

(21) Appl. No.: 18/958,894

(22) Filed: Nov. 25, 2024

(51) Int. Cl. G06N 3/042; G06N 3/092

(52) U.S. Cl. CPC G06N 3/042; G06N 3/092

(57) ABSTRACT

Systems and methods for resource management by optimizing actionable strategies are disclosed herein. A system generates a knowledge graph for a resource using a Graph Neural Network (GNN) transformer model based on input data related to the resource. The knowledge graph representing a current state of the resource includes nodes representing state attributes and edges representing dependencies between the state attributes. The system updates node features of the generated knowledge graph, selects appropriate child, and generates an expanded knowledge graph including the updated node features and the selected child nodes. The system further simulates the actions on the expanded knowledge graph based on a trained GNN transformer model and predicts an optimal action to be performed on the expanded knowledge graph based on the results of simulation. The system outputs the predicted optimal action to be performed on a user interface of a user device.

### TECHNICAL FIELD

Various embodiments described herein relate generally to system, method, and non-transitory computer readable medium for managing a resource by optimizing actionable strategies.

### BACKGROUND

Generally, cloud computing provides on-demand delivery of resources such as, computer networks, compute power, storage, servers, databases, networking software applications, software development environment, and/or the like, over the Internet. The resources are offered based on varying attributes such as, operational efficiency, budget, security, reliability, and/or the like.

With an exponential increase in use and growth of cloud computing, multiple cloud service providers exist for providing the resources. Due to having these multiple options for cloud service providers, the users may have a choice of hosting their applications and data in different cloud environments (e.g., multi-cloud environment including public clouds, private clouds, or a combination of both) for the resources. However, when the applications and the resources become more complex, it may be difficult for a user (e.g., Information Technology (IT) administrator) associated with an entity (e.g., enterprise) to perform any actions for managing the cloud environment, as the user may not obtain a view into an impact/risk of performing the actions. To illustrate, if the user wants to perform a particular action, for example, to reduce or increase the budget across the resources in the cloud environment, the user is required to understand an impact of the respective action on other attributes such as operational efficiency, security, reliability, and/or the like. Therefore, the user may require complex actionable strategies to perform the actions in the cloud environment for managing the resources as well as for managing the budget, and maintaining the security, the reliability, and operational efficiency of the resources.

Various modeling and simulation tools exist for generating the actionable strategies for managing the cloud environment. The actionable strategies may recommend the actions to be performed in the cloud environment by modelling and analyzing the various attributes of the resources in the cloud environment. However, the existing modeling and simulation tools may lack capabilities to dynamically adapt to changing scenarios or conditions of the cloud environment and to integrate insights across the attributes. Further, the existing modeling and simulation tools fail to capture complex interdependencies between the attributes. Therefore, the generated actionable strategies using the existing modeling and simulation tools may be inefficient, inaccurate, and inflexible. Such actionable strategies may be unacceptable and hinder operations of the entity being performed using the resources of the cloud environment.

### SUMMARY

In an aspect, the present disclosure relates to a system including a processor, and a memory communicably coupled to the processor, wherein the memory includes processor-executable instructions, which, when executed by the processor, cause the processor to receive input data corresponding to a plurality of initial conditions of a resource from a plurality of data sources, wherein the input data corresponds to initial states, configurations, and desired requirements of the resource, generate a knowledge graph for the resource using a Graph Neural Network (GNN) transformer model based on the received input data, wherein the knowledge graph corresponds to a current state of the resource, wherein the current state of the resource includes a plurality of state attributes represented as nodes and dependencies between the plurality of state attributes represented as edges, update node features of the generated knowledge graph with information from neighbouring nodes using the GNN transformer model, wherein the updated node features indicate changes in the plurality of state attributes and their dependencies, select appropriate child nodes based on the updated node features, wherein each child node represents at least one action, generate an expanded knowledge graph including the updated node features and the selected child nodes, simulate the actions on the expanded knowledge graph based on a trained GNN transformer model, predict an optimal action to be performed on the expanded knowledge graph based on the results of simulation, wherein the predicted optimal action includes policy and value predictions, and wherein the optimal action corresponds to a set of configurations and a set of attributes required to optimize the plurality of initial conditions, and output the predicted optimal action to be performed on a user interface of a user device.

In some examples, the processor may be further configured to update the expanded knowledge graph by performing the predicted optimal action in a simulation environment, wherein the updated knowledge graph indicates resulting changes in the plurality of initial conditions and wherein the updated knowledge graph comprises updated node features, updated plurality of state attributes and updated dependencies, and output the updated knowledge graph indicating the resulting changes on the user interface of the user device.

In some examples, to generate the knowledge graph for the resource using the GNN transformer model based on the received input data, the processor may be configured to receive the current state of the resource from the plurality of data sources, wherein the current state includes the plurality of state attributes, and wherein the plurality of state attributes includes at least one of resources, storage, network, budget, task automation, security efficiency, deployment frequency, and response time, assign each of the plurality of state attributes to each node of the knowledge graph, determine dependencies between the plurality of state attributes by correlating each of the plurality of state attributes, wherein the dependencies include at least one of an impact of increasing compute resources on network performance, an effect of reallocating budget on storage capacity, a relationship between a task automation and a security efficiency, assign each of the determined dependencies to each of the edges of the knowledge graph, and generate the knowledge graph for the resource using the GNN transformer model based on the assigned nodes and the edges.

In some examples, to update the node features of the generated knowledge graph with information from neighbouring nodes using the GNN transformer model, the processor may be configured to generate a message at each node by iteratively aggregating information from neighbouring nodes using an aggregation function, wherein the aggregation function includes one of a summation, an averaging, and attention-based weighted aggregation, and wherein the message includes encoded current state of the node, and the information includes at least one of edge weights and connection strengths, capture multi-hop dependencies between the nodes in the generated knowledge graph based on the generated message, determine changes in the plurality of state attributes and their dependencies based on the generated message and the captured multi-hop dependencies, and iteratively update the node features using the determined changes via a neural network layer until a final node feature for each of the nodes are determined, wherein the final node feature corresponds to a context-aware and dependency-reflective representation of a node state.

In some examples, to generate the expanded knowledge graph including the updated node features and the selected child nodes, the processor may be configured to select at least one action to apply onto the current state of each leaf node by processing the updated node features, wherein each leaf node includes the plurality of state attributes, generate a probability distribution for each of the selected at least one action using a soft max function, apply the selected at least one action onto the current state of each leaf node to determine changes to the current state based on the generated probability distribution, generate additional child nodes for each leaf node based on the selected at least one action, wherein the additional child nodes represent future states of the resource, and wherein each of the additional child nodes indicates an outcome of applying the selected at least one action to the leaf node, and generate the expanded knowledge graph including the additional child nodes, the updated node features, and the selected child nodes.

In some examples, to stimulate the actions on the expanded knowledge graph based on the trained GNN transformer model, the processor may be configured to perform simulation of the actions from a selected node to a terminal state based on the trained GNN transformer model, determine an update state and update dependencies within the expanded knowledge graph upon simulating the at least one action, and determine a performance of each updated state to determine a potential impact of selected at least one action on the resource.

In some examples, to predict the optimal action to be performed on the expanded knowledge graph based on the results of simulation, the processor may be configured to estimate an expected long-term reward for the current state of each node in the expanded knowledge graph based on a probability distribution of each action and a current state of each node, wherein the expected long-term reward includes an actual reward and a future reward, and predict the optimal action to be performed on the expanded knowledge graph based on the expected long-term reward.

In some examples, the processor may be further configured to determine a difference between predicted actions and actual actions executed during simulations, determine a gap between predicted rewards and actual rewards, and refine a policy and value predictions indicating the optimal action and associated rewards.

In some examples, to output the predicted optimal action to be performed on the user interface of the user device, the processor may be configured to convert the results of simulations into a plurality of actionable strategies to manage the resource, generate a plurality of recommendations to manage the resource based on the actionable strategies, and generate visual representations of the knowledge graph, the results of simulation, and predicted optimal action.

In another aspect, the present disclosure relates to a method including receiving, by a processor, input data corresponding to a plurality of initial conditions of a resource from a plurality of data sources, wherein the input data corresponds to initial states, configurations, and desired requirements of the resource. The method includes generating, by the processor, a knowledge graph, for the resource, using a Graph Neural Network (GNN) transformer model based on the received input data, wherein the knowledge graph corresponds to a current state of the resource, wherein the current state of the resource includes a plurality of state attributes represented as nodes, and dependencies between the plurality of state attributes represented as edges. The method includes updating, by the processor, node features of the generated knowledge graph with information from neighbouring nodes using the GNN transformer model, wherein the updated node features indicate changes in the plurality of state attributes and their dependencies. The method includes selecting, by the processor, appropriate child nodes based on updated node features, wherein each child node represents at least one action. The method includes generating, by the processor, an expanded knowledge graph including the updated node features and the selected child nodes. The method includes simulating, by the processor, the actions on the expanded knowledge graph based on a trained GNN transformer model. The method includes predicting, by the processor, an optimal action to be performed on the expanded knowledge graph based on results of the simulation, wherein the predicted optimal action includes policy and value predictions, and wherein the optimal action corresponds to a set of configurations and a set of attributes required to optimize the plurality of initial conditions. The method includes outputting, by the processor, the predicted optimal action to be performed on a user interface of a user device.

In another aspect, the present disclosure relates to a non-transitory computer-readable medium including machine-executable instructions that may be executable by a processor to perform the method as discussed herein.

It is appreciated that method in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features of the present disclosure will be apparent from the description and drawings, and from the claims.

### BRIEF DESCRIPTION OF THE FIGURES

Various implementations in accordance with the present disclosure will be described with reference to the drawings, in which:

FIG. 1 depicts an example environment that may be used to execute implementations of the present disclosure.

FIG. 2 depicts an exemplary architecture of a system for resource management by optimizing actionable strategies, in accordance with implementations of the present disclosure.

FIG. 3 depicts an exemplary conceptual architecture of a strategy optimization engine for generating the actionable strategies to manage the resource, in accordance with implementations of the present disclosure.

FIG. 4 depicts an exemplary cyclic architecture of an iterative strategy engine and a strategy policy training engine for generating training data and using the training data to train a Graph Neural Network (GNN) transformer model, respectively, in accordance with implementations of the present disclosure.

FIG. 5 depicts an exemplary process flow of generating the training data and training the GNN transformer model using the training data, in accordance with implementations of the present disclosure.

FIG. 6 depicts an exemplary process flow of generating training data for training the GNN transformer model, in accordance with implementations of the present disclosure.

FIGS. 7A and 7B depict exemplary code snippets illustrating generation of the knowledge graph by initializing the nodes, edges, and node features, in accordance with implementations of the present disclosure.

FIGS. 7C and 7D depict exemplary code snippets illustrating updating of the node features using the GNN transformer model, in accordance with implementations of the present disclosure.

FIG. 7E depicts an exemplary code snippet illustrating selection of child nodes, in accordance with implementations of the present disclosure.

FIG. 7F depicts an exemplary code snippet illustrating generation of an expanded knowledge graph, in accordance with implementations of the present disclosure.

FIG. 7G depicts an exemplary code snippet illustrating simulation of actions and a backpropagation phase, in accordance with implementations of the present disclosure.

FIG. 7H depicts an exemplary code snippet illustrating selectin of an optimal action, in accordance with implementations of the present disclosure.

FIGS. 8A, 8B, 8C, 8D, and 8E depict exemplary graph structures generated during different phases of generating the training data, in accordance with implementations of the present disclosure.

FIG. 9 depicts an exemplary process flow of training the GNN transformer model, in accordance with implementations of the present disclosure.

FIG. 10 depicts an exemplary conceptual architecture of the GNN transformer model, in accordance with implementations of the present disclosure.

FIG. 11A depicts an exemplary conceptual architecture of a policy network, in accordance with implementations of the present disclosure.

FIG. 11B depicts an exemplary conceptual architecture of a value network, in accordance with implementations of the present disclosure.

FIG. 12 depicts an example process of generating the optimal action for managing the resource using the trained GNN transformer model, in accordance with implementations of the present disclosure.

FIG. 13 depicts an exemplary architecture of the user device for selecting and implementing one of the actionable strategies for managing the resource, in accordance with implementations of the present disclosure.

FIG. 14 is flow diagram that presents a method for generating the optimal action for managing the resource, in accordance with implementations of the present disclosure.

FIG. 15 depicts an example computer system, in accordance with implementations of the present disclosure.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Reference to any “example” herein (e.g., “for example,” “an example of” by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to;” it specifically indicates open-ended inclusion or membership in the so-described combination, group, series, and the like.

The term “a” means “one or more” unless the context clearly indicates a single element.

“First,” “second,” and/or the like., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, and/or the like).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the disclosure as set forth in the claims.

This disclosure should be interpreted according to the exemplary definitions provided below. In case of a contradiction between the definitions in the definitions section and other sections of this disclosure, this section should prevail. In case of a contradiction between the definitions in this section and a definition or a description in any other document, including in another document incorporated in this disclosure by reference, this section should prevail, even if the definition or the description in the other document is commonly accepted by a person of ordinary skill in the art.

Implementations of the present disclosure enable generation of optimized actionable strategies for managing a resource. The actionable strategies may include an optimal action and/or recommendations to be implemented for managing the resource. The actionable strategies may be generated by simulating various actions and predicting associated results. The results of the simulation may reflect changes in conditions of state attributes of the resource after applying each of the actions. Thereby, the actionable strategies may be generated by integrating dependencies between the state attributes of the resource and ensuring that the conditions of a state attribute resultant from each action may be informed by and aligned with other state attributes. Such an integration may prevent siloed actionable strategies and provide the unified actionable strategies for managing the resource.

Implementations of the present disclosure further leverage an efficient Graph Neural Network (GNN) transformer model and optimization methods to reduce computational overhead associated with the simulation.

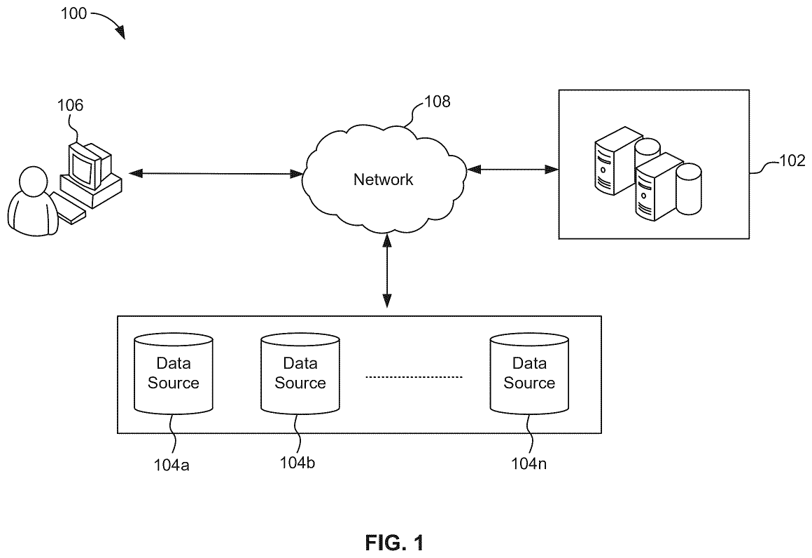

FIG. 1 depicts an example environment 100 that may be used to execute implementations of the present disclosure. In some examples, the example environment 100 enables generation of optimized actionable strategies (also be referred to as decision-makings, cloud management strategies, and/or the like) for managing resources.

As depicted in FIG. 1, the example environment 100 includes a system 102, data sources 104a-104n, and a user device 106. The system 102 (also be referred to as strategy optimization system) may be communicatively coupled with the data sources 104a-104n and the user device 106 using a network 108. In some examples, the network 108 may include, but is not limited to, a Local Area Network (LAN), a Wide Area Network (WAN), the Internet, or a combination thereof. In some other examples, the network 108 may be accessed over a wired and/or a wireless communication link.

The data sources 104a-104n may include input data related to resources. In some examples, the data sources 104a-104n may be managed by Enterprise Resource Planning (ERP) systems, Customer Relationship Management (CRM) platforms, cloud monitoring tools, security systems, and/or the like. In some examples, the resources may be referred to cloud environments, where optimization of compute resources and strategic planning of actions to be applied for optimization of the compute resources are essential. The cloud environments may be provided by different cloud service providers (CSPs). Further, each of the cloud environments may include a public cloud, a private cloud, and a combination thereof. In some other examples, the resource may be collectively referred to services, software applications, software development environment, computer networks, and/or the like, provided by the cloud environment. In some examples, the input data may correspond to initial conditions of the resource. In some examples, the initial conditions may indicate initial states, configurations, and desired requirements of the resource.

The user device 106 may be associated with a user, an Information Technology (IT) administrator, an IT leader, and/or an entity. In some examples, the user device 106 may include a desktop, smartphones, laptops, a tablet, and/or the like. The user device 106 may be used to provide input and/or receive output to/from the system 102. The user device 106 may present one or more user interfaces (e.g., Graphical User Interfaces (GUIs)) of a workspace for the user to interact with the system 102 for the actionable strategies.

In some examples, the system 102 may be implemented by way of a single device or a combination of multiple devices that may be operatively connected or networked together. The system 102 may be implemented in hardware or a suitable combination of hardware and software. The “hardware” may include a combination of discrete components, an integrated circuit, an application-specific integrated circuit, a field-programmable gate array, a digital signal processor, or other suitable hardware. The “software” may include one or more objects, agents, threads, lines of code, subroutines, separate software applications, two or more lines of code, or other suitable software structures operating in one or more software applications.

The system 102 may receive input data of a resource from the data sources 104a-104n. Based on the input data, the system 102 may identify a current state of the resource. Upon identifying the current state of the resource, the system 102 may use a Graph Neural Network (GNN) transformer model to explore various actions based on the current state of the resource and to determine a probability distribution of the actions. The system 102 may further generate training data by performing simulation of the actions on the current state of the resource and capturing data on results of the simulation. The data captured on the results of the simulation may include rewards calculated for the actions using the GNN transformer model and state transitions of the resource. Therefore, the training data may include state-action-reward-next state (SARS') sequences. The system 102 may use the training data to train the GNN transformer model to predict probability distribution over the actions and rewards for the actions. Such predictions may refine policy and value predictions for effective selection of the actions and forecasting of the rewards for the actions.

The system 102 may receive the input from the user device 106. The input may include actions to be applied on the current state of the resource. The system 102 may use the trained GNN transformer model to simulate the actions for managing the resource. Based on the results of the simulation, the system 102 may generate the actionable strategies. The actionable strategies may include an optimal action predicted from the actions for managing the resource and recommendations for optimizing utilization of the resource, while managing budget, and maintaining security, reliability, and operational efficiency of the resource.

Further, the system 102 may output the actionable strategies on the user interface of the user device 106. Therefore, the user device 106 may select and implement one or more of the recommendations included in the actionable strategies for managing the resource. Such an implementation may ensure that state attributes of the resource are optimized, while maintaining operational efficiency, budget, security, agility, and/or the like.

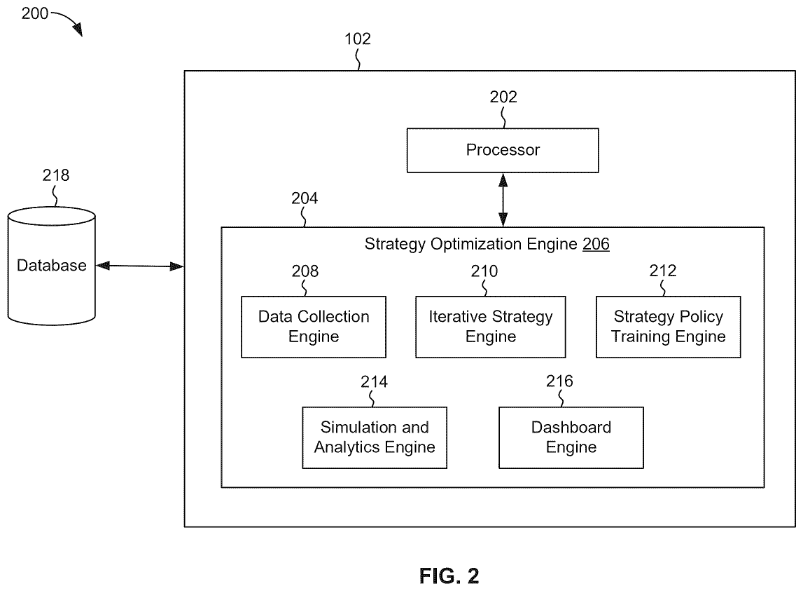

Various examples of generating the actionable strategies for managing the resource are described in detail in conjunction with FIGS. 2-15.

FIG. 2 depicts an exemplary architecture 200 of the system 102 for resource management by optimizing the actionable strategies, in accordance with implementations of the present disclosure.

The system 102 includes a processor 202 and a memory 204 communicably coupled to the processor 202. The processor 202 may include one or more processors. Examples of the processor 202 may include, but are not limited to, microprocessors, microcomputers, microcontrollers, digital signal processors, central processing units, state machines, logic circuits, and/or any devices that manipulate data or signals based on operational instructions. Among other capabilities, the processor 202 may fetch instructions (also referenced herein as processor-executable instructions) from the memory 204 and execute the fetched instructions for performing operations according to the present disclosure. The memory 204 may be non-volatile or non-transitory computer-readable medium, such as a magnetic disk or solid-state non-volatile memory or volatile medium such as Random Access Memory (RAM), and/or the like.

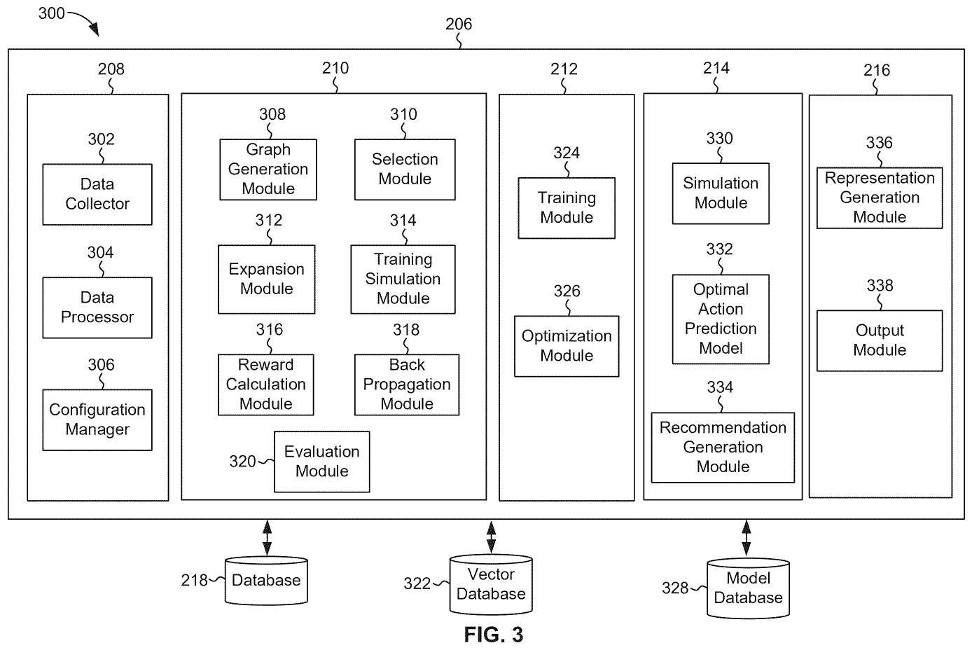

Further, the system 102 includes strategy optimization engine 206. The strategy optimization engine 206 may be stored in the memory 204 and provided as a downloadable library including the instructions. The strategy optimization engine 206 includes a data collection engine 208, an iterative strategy engine 210, a strategy policy training engine 212, a simulation and analytics engine 214, and a dashboard engine 216. The processor 202 may execute the components 208-216 of the strategy optimization engine 206 to perform intended functions according to the present disclosure (described in detail below). In addition, the system 102 includes a database 218, which stores various data and intermediate results generated by the components 208-216. The components 208-216 of the strategy optimization engine 206 are described in detail in conjunction with FIG. 3.

FIG. 3 depicts an exemplary conceptual architecture 300 of the strategy optimization engine 206 for generating the optimized actionable strategies to manage the resource, in accordance with implementations of the present disclosure.

In an example implementation, the processor 202 may execute the data collection engine 208 to receive the input data corresponding to the initial conditions of a resource. The data collection engine 208 includes a data collector 302 and a data processor 304.

The data collector 302 may receive the input data of the resource from the data sources 104a-104n (as depicted in FIG. 1). In some examples, the data collector 302 may receive the input data from the data sources 104a-104n through one or more of: Application Programming Interface (API) calls, software functions or methods (e.g., streams), a Secure File Transfer Protocol (SFTP) watcher, and/or the like. In some other examples, the data collector 302 may employ various modules (not shown) such as, but are not limited to, an application platform configurator module, cloud spend optimizer module, a security controller module, an operations module, and/or the like, to receive the input data of the resource across multiple verticals (e.g., operational efficiency, budget, security, agility, or the like) of an IT infrastructure.

The input data may correspond to the initial conditions of the resource. The initial conditions of the resource may identify initial states, configurations, and desired requirements of the resource. Thereby, a current state of the resource may be identified from the initial conditions of the resource.

In some examples, an initial state of the resource may indicate configurations of state attributes (also be referred to as metrics) of the resource. The state attributes may characterize the resource. Examples of the state attributes of the resource may include, but are not limited to, compute resources, storage, network, budget allocation, task automation, security efficiency, deployment frequency, response time, energy consumption, user satisfaction, and/or the like. By way of non-limiting example, the initial state of the resource may indicate that the resource has compute resources=85%, storage=70%, network=75%, budget allocation=$600,000, task automation=65%, security efficiency=80%, and deployment frequency=biweekly.

In some examples, the configurations may indicate values of features of each state attribute of the resource. Each state attribute may have multiple features. For example, the compute resources may have features such as, Central Processing Unit (CPU) utilization, memory utilization, Virtual Machines (VMs) count, container counts, and/or the like. The storage may have features such as, disk space utilization, database storage, file storage usage, backup storage usage, and/or the like. The network may have features such as, bandwidth utilization, latency, packet loss rate, network throughput, and/or the like. The budget allocation may have features such as, total budget, budget allocation to different verticals of the IT infrastructure, cost of the compute resources, cost of the storage, cost of the networking, and/or the like. The task automation may have features such as, automation level, a number of automated processes, an efficiency of automation, and/or the like. The security efficiency may have features such as, a threat detection rate, compliance level, a number of security incidents, time to detect or respond to threats, and/or the like. The deployment frequency may have features such as, frequency of software deployments, an average deployment time, a deployment success rate, and/or the like. The response time may have features such as, average response time for applications, peak response time, minimum response time, and/or the like. The energy consumption may have features such as energy usage by the compute resources, energy usage by the storage, energy usage by the network, and/or the like. The user satisfaction may have features such as a user satisfaction score, a number of complaints raised by the user, an average resolution time for issues reported by the user, and/or the like.

In some examples, the desired requirements of the resource may indicate state transitions for the resource. The state transitions may indicate a new state in which the initial conditions of the resource may be optimized. Alternatively, or additionally, the desired requirements of the resources may indicate actions to be applied for transiting to the new state from the current state of the resource. In an example, the desired requirements of the resource may indicate an action like scaling up of the compute resources by 10% for achieving transition to a new state of the resource with increased availability of the compute resources. In another example, the desired requirements of the resource may indicate an action like increasing task automation by 20% for achieving transition to a new state of the resource with enhanced operational efficiency. In yet another example, the desired requirements of the resource may indicate an action like reallocating 10% of the budget allocation from the storage to the compute resource for achieving transition to a new state of the resource with adjusted budget allocation.

In some implementations, the data collection engine 208 may include a configuration manager 306 for receiving the input data of the resource. The configuration manager 306 may provide an interactive interface for receiving the input data corresponding to the initial conditions of the resource from the user through the user device 106. The input data received from the user may reflect unique configurations of the resource and strategic targets employed by the entity (e.g., the desired requirements) for managing the resource.

Upon receiving the input data of the resource by the data collector 302 and/or the configuration manager 306, the data processor 304 may pre-process the input data. In some examples, pre-processing the input data may include cleaning and normalizing the input data. In some other examples, pre-processing the input data may include converting the input data into a structured format, when the input data is in an unstructured format. After pre-processing, the data processor 304 may store the input data in the database 218 for further processing.

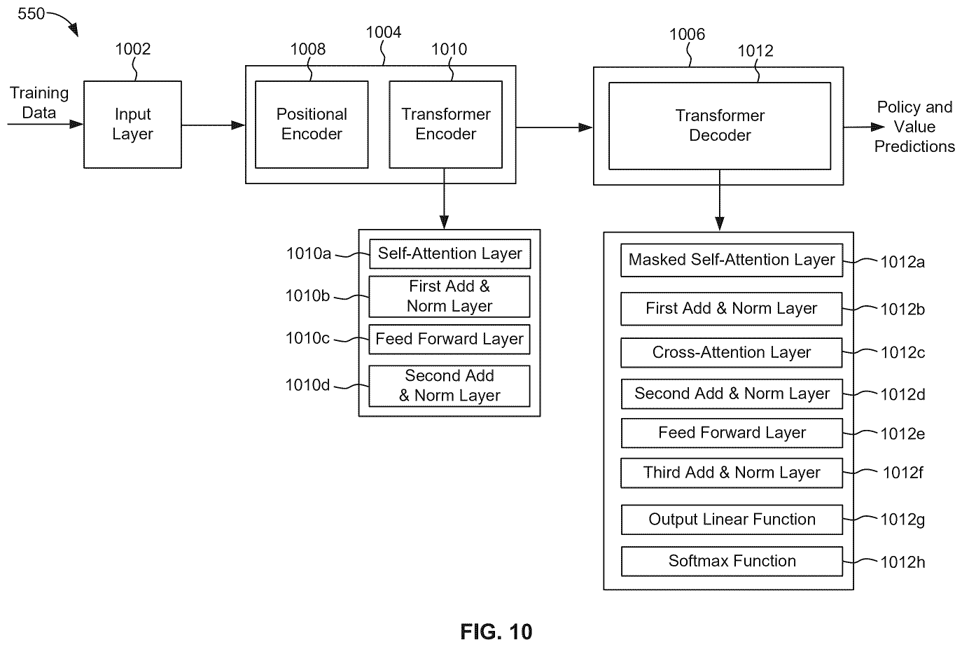

In an example implementation, the processor 202 may execute the iterative strategy engine 210 to generate training data for training the GNN transformer model. The trained GNN transformer model may be used to simulate actions in real-time for generating the actionable strategies to manage the resource. In an example implementation, the GNN transformer model may include an encoder-decoder model, which is described in detail in conjunction with FIG. 10. While implementations of the present disclosure are described in further detail herein with non-limiting reference to the encoder-decoder model as the example GNN transformer model, it is contemplated that implementations of the present disclosure may be realized using any appropriate Generative Artificial Intelligence (Gen AI) or foundation models, or Machine Learning (ML) models, or AI models.

The iterative strategy engine 210 includes a graph generation module 308, a selection module 310, an expansion module 312, a training simulation module 314, a reward calculation module 316, a back propagation module 318, and an evaluation module 320 for performing a guided exploration process from which the training data may be generated. The guided exploration process may involve an execution or selection phase, an expansion phase, a simulation phase, a backpropagation phase, and an action selection phase.

### Execution or Selection Phase:

In the execution or selection phase, the graph generation module 308 may receive the input data from the database 218 or the data collection engine 208 and generate a knowledge graph. The knowledge graph (also be referred to as tree, root node, and/or the like) may include nodes and edges.

For generating the knowledge graph, the graph generation module 308 may identify the current state of the resource from the input data. The current state of the resource may indicate initial conditions or initial configurations of the state attributes of the resource. The graph generation module 308 may assign each of the state attributes to each node of the knowledge graph. Therefore, the nodes of the knowledge graph may represent the state attributes of the resource (e.g., compute resources, storage, network, budget allocation, task automation, security efficiency, deployment frequency, response time, energy consumption, user satisfaction, and/or the like). The nodes may be modified (e.g., added or removed) dynamically by the user based on the desired requirements of the resource. Further, each node representing one of the state attributes may have the features of the state attributes (hereinafter referred to as node features). The node features may represent characteristics of a respective node or state attribute. For example, a node corresponding to the compute resource may have the node features such as CPU utilization, memory usage, and associated cost. For another example, a node corresponding to the storage may have node features such as disk utilization, data volume, and storage costs. For yet another example, a node corresponding to the network may have node features such as bandwidth utilization, latency, and network costs.

The graph generation module 308 may determine dependencies or relationships between the state attributes (e.g., the nodes) by correlating each of the state attributes. The graph generation module 308 may assign each of the determined dependencies to each of the edges between the respective nodes. Therefore, the dependencies may correspond to the edges. The dependencies or relationships (e.g., edges) may vary based on how changes in a state attribute affect or impact other state attributes of the resource. In some examples, the dependencies or the edges may be determined between the state attributes/nodes of the resources such as:
Compute resources and response time: Increased compute resources may reduce response time.
Budget allocation and task automation: High budget allocation may allow for high task automation.
Budget allocation and security efficiency: Increased budget may improve security measures.
Compute resources and energy consumption: A large number of compute resources may lead to high energy consumption.
Storage and energy consumption: More storage may lead to high energy consumption.
Network and response time: Improved network performance may improve response time.
Task automation and user satisfaction: High task automation may improve user satisfaction by reducing errors and speeding up processes.
Security efficiency and user satisfaction: Improved security measures may lead to high user satisfaction by preventing incidents.
Deployment frequency and user satisfaction: A large number of frequency and successful deployments may lead to high user satisfaction.
Response time and user satisfaction: Low response time may lead to high user satisfaction.
Compute resources and budget: Adding a large number of compute resources may impact the budget allocation.
Storage and budget: Increased storage may impact budget allocation.
Network and budget: Enhanced network capabilities may impact budget allocation.

Once the nodes and the edges are assigned with the state attributes and the dependencies, respectively, the graph generation module 308 may use the GNN transformer model to generate the knowledge graph based on the assigned nodes and edges. Therefore, the knowledge graph may be generated by initializing the nodes and edges.

Further, in the selection phase, the selection module 310 may update the node features of the knowledge graph and generate child nodes based on the updated node features.

Updating the node features may refer to updating values of the node features. For updating the node features of the knowledge graph, the selection module 310 may generate a message at each node by iteratively aggregating information from neighbouring nodes using an aggregation function. In some examples, the message generated at each node may include encoded current state of the respective node. In some examples, the information aggregated from the neighbouring nodes may include edge weights and connection strengths. In some examples, the aggregation function may include one or more of: a summation, an averaging, and an attention-based weighted aggregation. Based on the message generated at each node, the selection module 310 may capture multi-hop dependencies between the nodes in the knowledge graph. Further, based on the message generated at each node and the captured multi-hop dependencies, the selection module 310 may determine changes in the state attributes and their dependencies. Using the determined changes, the selection module 310 may iteratively update the node features via the GNN transformer model until a final node feature for each of the nodes are determined. The final node feature may correspond to a context-aware and dependency-reflective representation of a node state.

Once the node features are updated, the selection module 310 may select appropriate child nodes by evaluating the nodes and the updated node features. Each of the child nodes may represent actions to be performed for managing the resource. The actions may include varying or modifying the state attributes of the resource. For example, the actions may include, but are not limited to, increasing compute resources, reallocating budget to storage, enhancing task automation, improving task automation, reducing deployment frequency, and/or the like. In an implementation, the selection module 310 may use a Transformer-backed Monte-Carlo Tree Search (MCTS) method to select the appropriate child nodes. In accordance with the MCTS method, the appropriate child nodes may be successively selected until one or more leaf nodes are reached. The one or more leaf nodes may be nodes that may have further potential child nodes and have not been fully expanded or never traversed.

### Expansion Phase:

In the expansion phase, the expansion module 312 may expand the knowledge graph by generating an expanded knowledge graph including the update node features and the selected appropriate child nodes.

For generating the expanded knowledge graph, at each leaf node, the expansion module 312 may select one or more actions to be applied to the current state of the resource. For selecting the one or more actions, the expansion module 312 may use the GNN transformer model to generate a probability distribution over all the actions selected from the nodes of the knowledge graph (e.g., the actions represented by the child nodes). The probability distribution may indicate probabilities of the actions. The probability distribution may reflect a likelihood of each action leading to a favorable outcome. Based on the probability distribution, the expansion module 312 may select the one or more actions from the actions. The one or more actions may be associated with the highest probability over the other actions.

Once the one or more actions are selected, the expansion module 312 may apply the selected one or more actions onto the current state of each leaf node to determine changes to the current state of the resource. Further, the expansion module 312 may generate additional child nodes for each leaf node after applying the selected one or more actions. The additional child nodes may represent future states of the resources. Each of the additional child nodes may indicate an outcome of applying the selected one or more actions. Upon generating the additional child nodes, the expansion module 312 may generate the expanded knowledge graph including the additional child nodes, the updated node features, and the selected child nodes. Once the expanded knowledge graph is generated, the expansion module 312 may enable the selection module 310 to update all the node features in the expanded knowledge graph using the GNN transformer model. The node features in the expanded knowledge graph may be updated by aggregating the information from the neighbouring nodes. The updated node features in the expanded knowledge graph may reflect changes to the state attributes of the resource.

### Simulation Phase:

In the simulation phase, the training simulation module 314 may perform simulation of the one or more actions on the current state of the resource. The simulation may be iteratively performed starting from the additional child nodes in the knowledge graph, until reaching a terminal node. Further, the training simulation module 314 may perform a rollout to explore the outcomes resultant from the simulation of the one or more actions. The outcomes may be evaluated to determine how the current state of the resource may evolve in future. During the rollout, the additional child nodes may be expanded based on future actions. The additional child nodes may be expanded by considering only one additional child node at each step (e.g., an additional child node with the highest probability). After performing the simulation, the training simulation module 314 may update the expanded knowledge graph by updating the node features of each of the nodes (including the child nodes, the additional child nodes, or the like). The updated expanded graph may reflect changes occurred in the state attributes of the resource after the simulation.

Further, in the simulation phase, the reward calculation module 316 may calculate rewards of the actions based on outcomes or results of the simulation of the actions. The rewards may include actual rewards (also be referred to as immediate rewards) and expected long-term rewards (also be referred to as cumulative rewards).

The reward calculation module 316 may calculate the actual rewards for the actions by determining the outcomes or results of the simulation of the actions on the state attributes of the resource. The outcomes or results may indicate actual/immediate impacts or consequences resultant from the simulation of the actions on the state attributes of the resource. The reward calculation module 316 may also calculate the expected long-term rewards for the actions based on the actual rewards and future rewards. The future rewards may indicate expected impacts or costs associated with continuing the simulation for a long-term, in a decision path followed by the respective actions. Upon calculating the rewards, the reward calculation module 316 may enable the selection module 310 to update all the node features in the expanded knowledge graph based on the actual rewards.

### Backpropagation Phase:

In the backpropagation phase, the backpropagation module 318 may perform backpropagation to backpropagate the results of the simulation through the expanded knowledge graph. After the backpropagation, the backpropagation module 318 may use the GNN transformer model to update value estimates of the nodes in the expanded knowledge graph based on the rewards calculated from the results of the simulation. Further, the backpropagation module 318 may enable the GNN transformer model to learn from the results of the simulation to adjust probability distribution over future actions.

### Action Selection Phase:

The evaluation module 320 may determine whether to continue performing the simulation by determining if a predefined criteria have been met. The predefined criteria (also be referred to as game end criteria) may indicate targets predefined for the simulation or a predefined stability period. When it has been determined that the predefined criteria have not been met, the evaluation module 320 may enable the training simulation module 314 to continue the simulation.

When it has been determined that the predefined criteria have been met, the evaluation module 320 may select an optimal action based on results of previous simulations and expansions of the knowledge graph. In some examples, the evaluation module 320 may select an action corresponding to a node (in the expanded knowledge graph) having the highest value estimates among the others as the optimal action. In some other examples, the evaluation module 320 may select an action corresponding to a node, which has been highly traversed or visited in the expanded knowledge graph. Once the optimal action is selected, the evaluation module 320 may enable the selection module 310 to update the node features in the expanded knowledge graph to reflect results that may be achieved after the optimal action has been applied.

Further, the evaluation module 320 may prepare the training data based on the results of the previous simulations and expansions. The training data may include the state indicating state transitions of the resource observed during the previous simulations and expansions, the actions performed during the previous simulations, the rewards calculated based on the results of the previous simulations, and a future or next state of the resource. The future or next state of the resource may be predicted based on the actions performed during the previous simulation. The evaluation module 320 may store the training data in a vector database 322.

In an example implementation, the processor 202 may execute the strategy policy training engine 212 to train the GNN transformer model based on the training data. The strategy policy training engine 212 includes a training module 324 and an optimization module 326.

The training module 324 may collect the training data from the iterative strategy engine 210 or the vector database 322. The training module 324 may use the collected training data for training of the GNN transformer model. The GNN transformer model may be trained to predict the probability distribution over the actions and to calculate rewards for the actions. The probability distribution may determine an action, which is most likely to lead to the favorable outcomes. The rewards calculated for each action may influence an overall decision-making process by providing long-term forecasts for action effectiveness. Therefore, the trained GNN transformer may be used to determine policy and value predictions for the actions.

The optimization module 326 may optimize the GNN transformer model by tuning parameters or hyperparameters of the trained GNN transformer model. The optimization module 326 may calculate a policy loss based on the probability distribution predicted using the GNN transformer model. Also, the optimization module 326 may also calculate a value loss based on the rewards calculated using the GNN transformer model. The optimization module 326 may enable the training module 324 to iteratively train the GNN transformer model until the packet loss and the value loss have been minimized. The packet loss and the value loss may be minimized based on the results of the previous simulations and expansions. In an implementation, the GNN transformer model may be iteratively trained by optimizing the parameters of hyperparameters of the GNN transformer model and evaluating performance of the GNN transformer model based on one or more evaluation metrics. In some examples, the parameters or hyperparameters of the GNN transformer model may be trained using an optimizer (e.g., Adam) and a learning rate scheduler. In some examples, the evaluation metrics may include, but are not limited to, accuracy, precision, recall, and/or the like. The iterative training of the GNN transformer model may result in the trained GNN transformer model, which may be an optimized transformer model. The trained GNN transformer model may be stored in a model database 328.

In an example implementation, the processor 202 may execute the simulation and analytics engine 214 to simulate actions on the current state of the resource and predict an optimal action to be performed based on results of the simulation. The simulation and analytics engine 214 includes a simulation module 330, an optimal action prediction module 332, and a recommendation generation module 334.

The simulation module 330 may obtain the trained GNN transformer model from the model database 328 and use the trained GNN transformer model to simulate the actions on the expanded knowledge graph. In some examples, the actions may be selected by the user device 106 for managing the resource. For simulating the actions, the simulation module 330 may select a node in the expanded knowledge graph. Upon selecting the node, the simulation module 330 may perform simulation of the actions from the selected node to the terminal node using the trained GNN transformer model. After performing the simulation of the actions, the simulation module 330 may determine an update state and update dependencies within the expanded knowledge graph. The update state and the update dependencies may reflect changes to the resource after applying the actions on the current state of the resource. The simulation module 330 may determine a performance of each updated state to determine a potential impact of the actions on the state attributes of the resource.

The optimal action prediction module 332 may predict the optimal action to be performed on the expanded knowledge graph based on the results of simulation. The optimal action may correspond to a set of configurations and a set of attributes required to optimize the initial conditions of the resource.

The optimal action prediction module 332 may use the trained GNN transformer model to determine the probability distribution of the actions and the value predictions of the nodes in the expanded knowledge graph. Thereby, the policy and value predictions may be determined. Based on the probability distribution of each action and the current state of each node, the optimal action prediction module 332 may estimate an expected long-term reward for the current state of each node. The expected long-term reward includes an actual reward and a future reward. Based on the expected long-term reward, the optimal action prediction module 332 may predict the optimal action to be performed on the expanded knowledge graph.

Once the optimal action is predicted, the simulation module 330 may update the expanded knowledge graph by performing the predicted optimal action in a simulation environment. The updated knowledge graph may indicate resulting changes in the initial conditions of the resource. The updated knowledge graph may include updated node features, updated state attributes and updated dependencies.

The recommendation module 334 may generate the recommendations for managing the resource. The recommendation module 334 may convert the results of the simulation into the actionable strategies. Based on the actionable strategies, the recommendation module 334 may generate the recommendations to manage the resource. The recommendations may indicate one or more tasks to be performed for managing the resource. For example, if the user selects the actions for modifying the distribution of the budget across different services provided by the resource (e.g., cloud environment), the generated recommendations may include recommendations for redistributing or reallocating the budget from the storage to the compute resources, recommendations for optimizing operational processes, recommendations for decreasing the budget for underutilized compute resources, and/or the like. Using such recommendations, the user of the user device 106 may plan to increase or decrease the budget across the various services or redistributing the budget from one service to another, and/or the like.

In an example implementation, the processor 202 may execute the dashboard engine 216 to output the recommendations, the predicted optimal action, the knowledge graph, and the results of the simulation on the user interface of the user device. The dashboard engine 216 may include a representation generation module 336 and an output module 338.

The representation generation module 336 may generate visual representations of the knowledge graph, expanded knowledge graph, the results of the simulation, the predicted optimal action, the updated knowledge graph resulting from performing the optimal action, the recommendations, and/or the like.

The output module 338 may output the generated visual representations on the user interface of the user device 106. In some examples, the visual representations may be outputted in an intuitive format using graphs, charts, heatmaps, textual strategies, and/or the like. Therefore, the visual representations may aid the user in visualizing complex data and outcomes to understand an impact of the selected actions and the actionable strategies to be deployed for managing the resource. Further, based on the actionable strategies, the user may make informed decisions for managing the resource. Therefore, the system 102 may provide a “what-if” simulation tool for the user, so that the user of the user device 106 may understand an impact of each action on the state attributes of the resource by simulating the respective action on the current state of the resource. In addition, the system 102 may indicate the optimal action and the recommendations for optimizing the initial conditions of the resource.

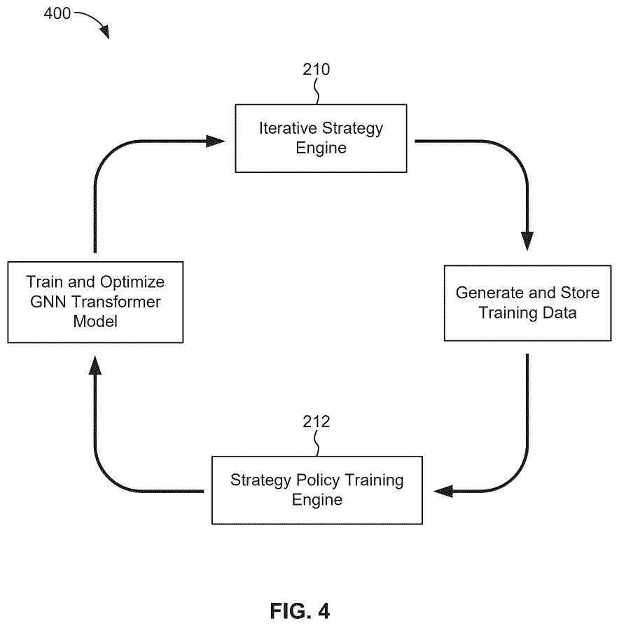

FIG. 4 depicts an exemplary cyclic architecture 400 of the iterative strategy engine 210 and the strategy policy training engine 212, in accordance with implementations of the present disclosure.

The iterative strategy engine 210 may receive the input data of the resource and generate the training data for training of the GNN transformer model. The iterative strategy engine 210 may leverage the MCTS method enhanced with the GNN transformer model to iteratively, select, expand, and simulate the actions. The actions may be for managing the resource. The iterative strategy engine 210 may begin with a current state of the resource, perform simulations of the actions to explore an impact of the actions on the state attributes of the resource, and generate the training data. Such an iterative process may ensure a detailed exploration of strategy space. The training dataset may include a robust dataset capturing a state(S), actions (A), rewards (R), and a future or next state of the resource (S′). The state(S) may indicate the current state of the resource represented as the knowledge graph capturing the state attributes such as, compute resources, storage, network, budget, task automation, security efficiency, deployment frequency, response time, and/or the like. The actions (A) may indicate specific actions performed from the current state, for example, increasing the compute resources, reallocating budget, and/or the like. The rewards (R) may indicate both the actual rewards (e.g., performance improvements) and the expected long-term rewards (e.g., long-term cost savings) resultant from the actions. The future or next state (S′) may indicate a resultant state of the environment after applying the action. The resultant state may be represented as the expanded knowledge graph. The iterative strategy engine 210 may generate vector representations for the state(S), the actions (A), the rewards (R), and the future or next state (S′), respectively, and store the vector representations in the vector database 322. Thereby, a comprehensive repository of the state-action-reward-next state (SARS') sequences may be created and stored in the vector database 322 for training of the GNN transformer model.

The strategy policy training engine 212 may receive the stored training data from the vector database 322 and train the GNN transformer model. Training of the GNN transformer model may involve a policy network training and a value network training. The policy network training may involve training the GNN transformer model based on the training data to learn the probability distribution over the actions from each state of the resource. The policy network training may aid in predicting the optimal actions for managing the resource. The value network training may involve training the GNN transformer model based on the training data to learn to predict the rewards for each of the actions. The value network training may aid in evaluating the expected long-term rewards of the actions.

In some implementations, the strategy policy training engine 212 may use the training data to identify predicted actions and actual actions executed during the simulations. Also, the strategy policy training engine 212 may use the training data to identify precited rewards for the predicted actions and actual rewards for the actual actions. Further, the strategy policy training engine 212 may determine a difference between the predicted actions and the actual actions. Similarly, the strategy policy training engine 212 may determine a gap between the predicted rewards and the actual rewards. The strategy policy training engine 212 may iteratively perform the policy network training and the value network training of the GNN transformer model to reduce the determined difference between the predicted and actual actions and gap between the predicted and actual rewards. The iterative training of the GNN transformer model may result in the trained or refined GNN transformer model capable of indicating the optimal action and the associated rewards. Thereby, the policy and value predictions may be refined.

Further, the trained GNN transformer model may be optimized by iteratively tuning the hyperparameters of the trained GNN transformer model until the policy loss and the value loss derived from the policy and value predictions have been minimized. The trained and optimized GNN transformer model may be integrated into the iterative strategy engine 210, which may enhance capability of the iterative strategy engine 210 to simulate more accurate and effective actions. The trained GNN transformer model may use the refined policy and value predictions to guide the selection of the optimal action and the associated rewards, which may ensure a targeted and efficient exploration of the strategy space. Such a continuous feedback loop, where the trained GNN transformer model may affect the iterative strategy simulations, while ensuring ongoing optimization and improvement of the actionable strategies. The actionable strategies may provide the user with the robust and actionable recommendations for managing the resource.

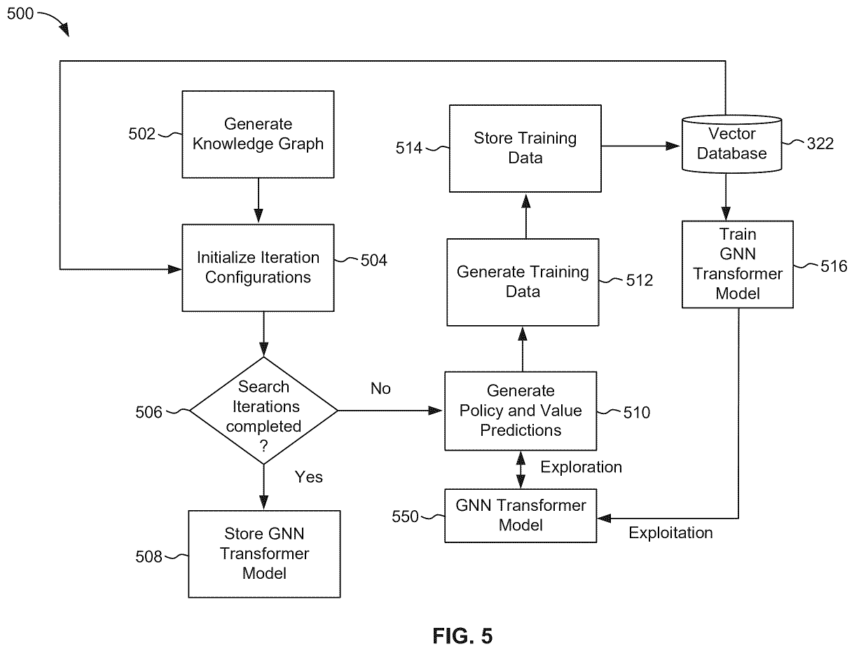

FIG. 5 depicts an exemplary process flow 500 of generating the training data and training a GNN transformer model 550 using the training data, in accordance with implementations of the present disclosure.

At step 502, the iterative strategy engine 210 generates the knowledge graph based on the input data corresponding to the initial conditions of the resource. At step 504, the iterative strategy engine 210 initializes iteration configurations indicating a number of search iterations to be performed for simulating the actions. At step 506, the iterative strategy engine 210 checks if the indicated number of search iterations has been completed. If the number of search iterations has been completed, at step 508, the strategy policy training engine 212 stores the GNN transformer model 550.

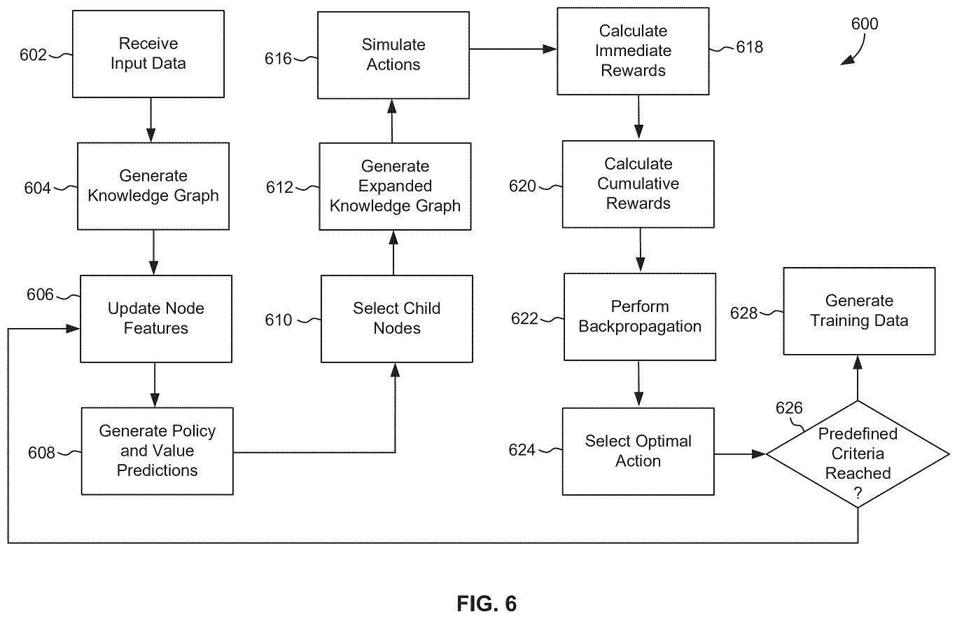

If the number of search iterations has not been completed, at step 510, the iterative strategy engine 210 uses the GNN transformer model 550 to generate the policy and value predictions. At step 512, the iterative strategy engine 210 generates the training data by exploring various actions based on the policy and value predictions, which is described in detail in FIG. 6. The iterative strategy engine 210 may use the policy and value predictions for selection of the child nodes for the nodes in the knowledge graph and for further expansion of the knowledge graph, thereby generating the expanded knowledge graph. Further, the iterative strategy engine 210 may simulate the actions on the expanded knowledge graph, calculate the rewards based on the results of the simulation, and backpropagates the results to refine the node features. Such a process may generate the training data including the state-action-reward-next state (SARS') sequences. At step 514, the iterative strategy engine 210 stores the training data in the vector database 322 in a form of vector representation.

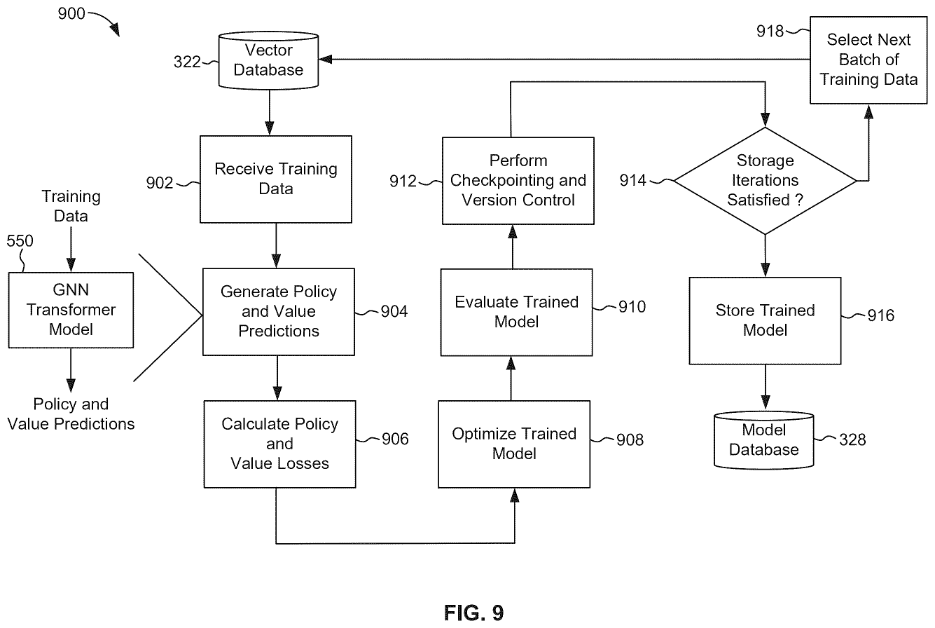

After storing the training data, at step 516, the strategy policy training engine 212 uses the training data to train the GNN transformer model 550, which is described in detail in FIG. 9. Thereby, the strategy policy training engine 212 may exploit the trained GNN transformer model to refine the policy and value predictions. Further, after storing the training data, steps 504-516 may be iteratively performed until the number of search iterations have been completed.

FIG. 6 depicts an exemplary process flow 600 of generating the training data for training the GNN transformer model, in accordance with implementations of the present disclosure.

At step 602, the iterative strategy engine 210 receives the input data corresponding to the initial conditions of the resource. The initial conditions may include the initial states, the configurations, and the desired requirements of the resource. In some examples, the input data may be received from the data sources 104a-104n. In some other examples, the input data may be received from the user of the user device 106. In such a scenario, various configurations may be displayed on the user interface of the user device 106 along with a slider. The user may be allowed to adjust or tune the slider for selecting the configurations of the resource or define the desired requirements of the resource.

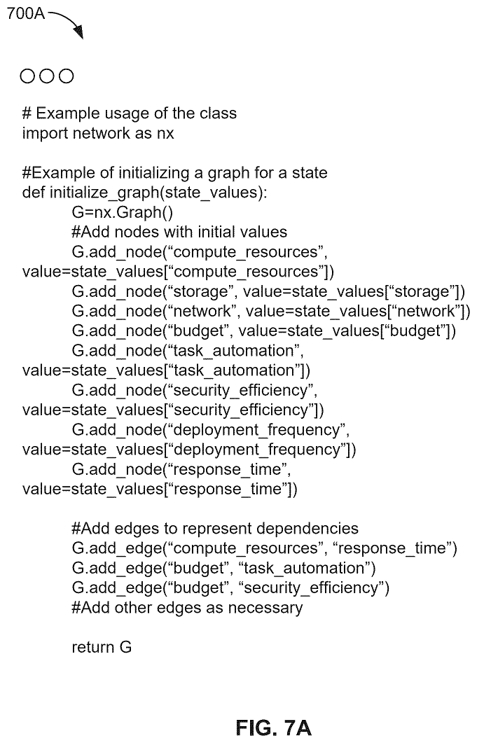

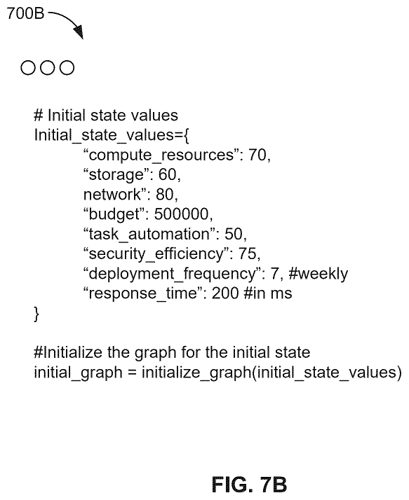

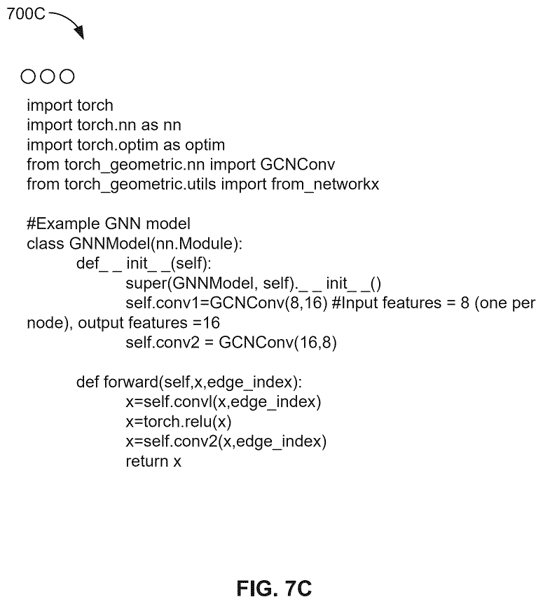

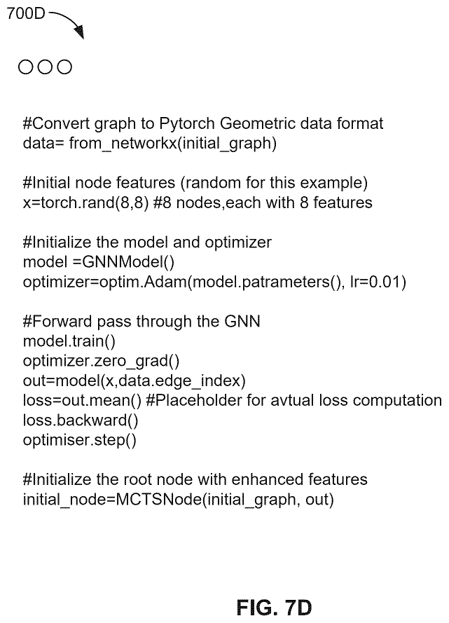

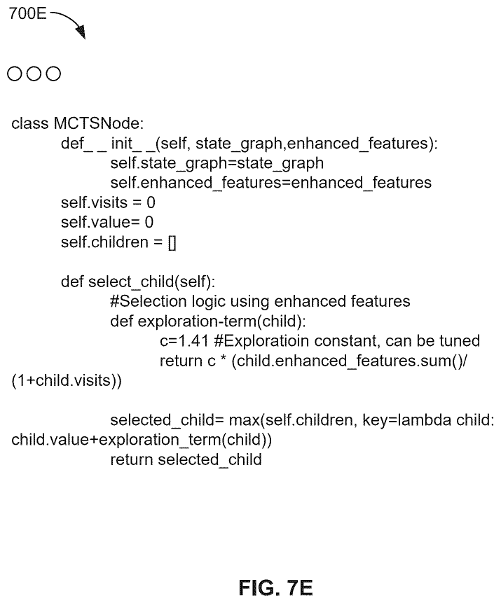

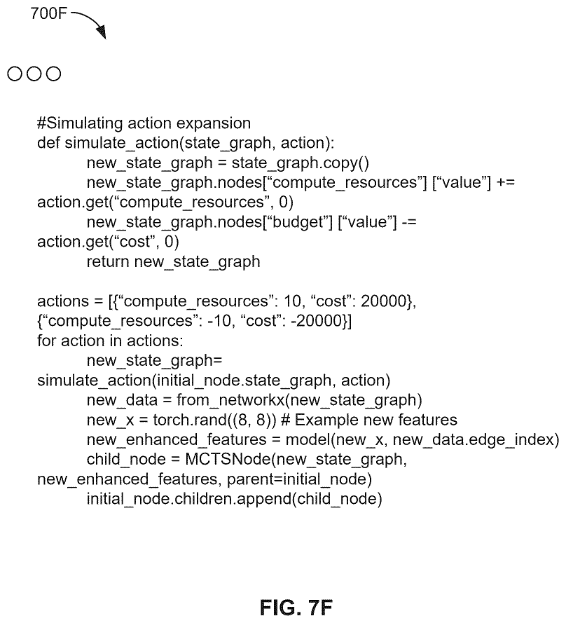

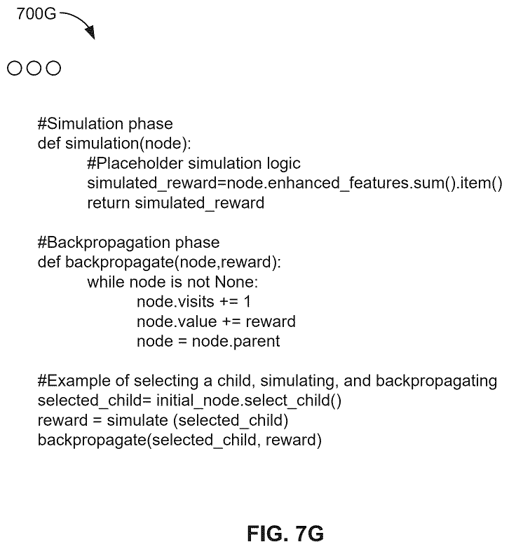

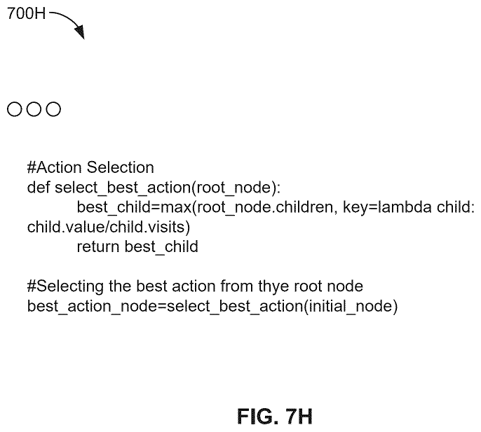

At step 604, the iterative strategy engine 210 generates the knowledge graph corresponding to the current state of the resource. The current state of the resource may be identified based on the initial states and the configurations included in the input data. The knowledge graph may be generated by initializing the nodes of the knowledge graph with the state attributes of the resource and the edges between the nodes with the dependencies between the state attributes of the resource. The edges may depict possible actions or changes in the state attributes of the resource. Examples of the actions may include, but are not limited to, increasing/decreasing compute resources (e.g., vertical or horizontal scaling), reallocating budget (e.g., prioritizing budget toward storage or compute based on need), enhancing task automation (e.g., integrating new DevOps tools to improve deployment frequency), optimizing network performance (e.g., rerouting traffic to minimize latency), enhancing security (e.g., implementing encryption or access controls), and/or the like. Exemplary code snippets 700A and 700B illustrating generation of the knowledge graph by initializing the nodes, edges, and node features are depicted in FIGS. 7A and 7B.

At step 606, the iterative strategy engine 210 updates the node features of each of the nodes in the knowledge graph using the GNN transformer model. The iterative strategy engine 210 may convert the knowledge graph into a format suitable for processing using the GNN transformer model. After converting the format of the knowledge graph, the iterative strategy engine 210 may aggregate the information (e.g., the edge weights and connection strengths) from the neighbouring nodes and process the aggregated the information using the GNN transformer model to update the node features of each of the nodes. Thereby, richer and context-aware representation of the current state may be obtained.

In an example implementation, consider that each node may start with the node features, which may be represented in a form of an initial feature vector hi⁰, where ‘i’ indicates a node index. For example, a node corresponding to the compute resource may have the node features like hcompute(0)=[CPU_utilization, VM_count, cost]. For updating the node features, the iterative strategy engine 210 may enable sending of a message from each node to its neighbouring nodes. The message may encode the current state of the node and may include the information like the edge weights or connection strengths. In an example implementation, a message from a node ‘i’ to a node ‘j’ may be represented as:

$$mij = Function ( hi , hj , edge\_attributesij )$$

where ‘Function’ may be a simple linear transformation, attention mechanism, or more complex function.

Upon passing the message, at each node, the iterative strategy engine 210 may aggregate the information by aggregating the messages received from the neighbouring nodes. The aggregation may include summation, averaging, or functions such as max-pooling or attention-based weighted sums. For example, for the node corresponding to the storage, the aggregation of the messages may involve summing the messages about data transfer that may further impact the compute resources and bandwidth from the network. In an example implementation, the aggregation of the messages may be represented as:

$$Aggregation for node ‘ {j}^{′} : aj = Aggregate ( \{ mij \vert i ∈ Neighbors ( j ) \} )$$

Once the messages are aggregated at each node, the iterative strategy engine 210 may update the node features of each node by processing the aggregated messages at the respective node using a neural network layer of the GNN transformer model. The neural network layer may include a fully connected layer followed by non-linear activation function. For example, for a node corresponding to the network, the updated node features may include refined estimated of latency, which is adjusted based on an increase in compute load and associated data transfer requirements.

In an example implementation, the node feature ‘j’ may be updated as:

Feature update for node ‘j’: hj(t+1)=Update(hj(t),aj), where ‘t’ is an iteration step.

The iterative strategy engine 210 may perform multiple iterations of passing the messages between the nodes and aggregating the information by aggregating the messages at each of the nodes to update the node features. Each iteration may allow the messages to propagate further through the knowledge graph, which may aid in capturing more complex dependencies between the nodes. After performing the multiple iterations, the node features of each node (hi(T)) may encapsulate not only the initial state of the respective node but also influences the initial states of the neighbouring nodes in the knowledge graph.

Consider an example scenario, wherein a knowledge graph of a resource includes a node corresponding to compute resources (hereinafter referred to as compute node). The compute node features may include CPU utilization=80%, VM count=10, and cost=$2000. Further, in the knowledge graph, the compute node may have neighbouring nodes such as a node corresponding to budget (hereinafter referred to as budget node), and a node corresponding to network (hereinafter referred to as network node). In such a scenario, the iterative strategy engine 210 enables passing of a message from the compute node to the network node, wherein the message indicates the CPU utilization, the VM count, and the cost. The iterative strategy engine 210 also enables passing of a message from the network node to the compute node, wherein the message indicates potential impacts on latency and bandwidth based on increased compute load. At the compute node, the iterative strategy engine 210 aggregates the information based on the message received from the network node and a message received from the budget node. If the message from the budget node indicates a limit on spending and the message from the network node indicates increased load, then bandwidth availability has to be reduced. Based on the aggregated information at the compute node, the iterative strategy engine 210 may update the node features of the compute node by adjusting CPU utilization predictions, expected costs, and impacts on performance. For instance, if adding VMs increases both cost and network usage beyond the budget, the updated node features of the compute node may reflect a recommendation against expanding the compute resources without first reallocating budget. The iterative strategy engine 210 may perform passing and aggregation of the messages at the compute node across multiple iterations to refine or update the node features of the compute node by considering indirect effects (e.g., storage node impacts as influenced by the network node).

In an example, updating the node features of the nodes may include the following initializations:
Node: Compute Resources (Current Values):
Features: CPU/GPU utilization may be updated with current usage of processing power.
   Instance Count may be updated with a number and type of instances currently in use.
   Idle time may be updated with how much processing time is being wasted due to underutilization.
Node: Storage (Current Values):
Features: Storage capacity may be updated with current storage consumption vs. capacity limits.
   Read/Write speeds may be updated with performance metrics such as Input/Output Operations per Second (IOPS).
   Storage costs may be updated with current spend on block, object, and file storage solutions.
Node: Network (Current Values):
Features: Bandwidth usage may be updated with current data transfer rates and allocated bandwidth.
   Network latency may be updated with time that takes for a packet to travel between two points in the cloud environment.
   Network traffic costs may be updated with current costs associated with data transfers, including intra-region and inter-region traffic.
Node: Budget (Current Values):
Features: Total budget may be updated with an overall allocated budget for the cloud environment.
   Current spend may be updated current expenditure across various services provided by the cloud environment.
   Unused budget may be updated with a remaining amount available for reallocation of the compute resources.
Node: Task Automation (Current Values):
Features: Automated processes may be updated with a number of automated processes currently executing.
   Manual interventions may be updated with instances, where human intervention is required.
   Automation efficiency may be updated with a measure of how effective current automation strategies are (e.g., deployment time, error reduction).
Node: Security Efficiency (Current Values):
Features: Vulnerability score may be updated with current security posture in terms of vulnerabilities and open risks.
   Security automation may be updated with automated responses to security threats and incidents.
   Encryption and access control may be updated with status of encryption policies and access control measures.
Node: Deployment Frequency (Current Values):
Features: Release frequency may be updated with a number of deployments/releases over a defined period.
   Deployment success rate may be updated with a ratio of successful to failed deployments.
   Pipeline efficiency may be updated with time taken for a code to move from development to production in the cloud environment.
Node: Average Response Time (Current Values):
Features: Application response times may be updated with current average response time estimated for the services provided by the cloud environment.
   Latency issues may be updated with any existing latency-related issues or bottlenecks in the cloud environment.
   Service-Level Agreement (SLA) compliance may be updated to indicate whether the cloud environment meets agreed or predefined response time commitments.

Exemplary code snippets 700C and 700D illustrating updating of the node features using the GNN transformer model are depicted in FIGS. 7C and 7D.

At step 608, the iterative strategy engine 210 generates the policy and value predictions by processing the knowledge graph using the GNN transformer model. The policy and value predictions may include the probability distribution of all the possible actions from the nodes of the knowledge graph and the associated rewards. For example, consider that there are 5 possible actions corresponding to 5 nodes in the knowledge graph. In such a scenario, the policy and value predictions generated using the GNN transformer model may include probability distribution for the 5 actions. In an example, the policy and value predictions may include the following probability distribution (P) indicating probabilities for the 5 actions:

$$P = \{ 0.01 , 0.6 , 0.2 , 0.15 , 0.04 \}$$

Based on the policy and value predictions, at step 610, the iterative strategy engine 210 selects the child nodes using the MCTS method. An exemplary code snippet 700E illustrating selection of the child nodes is depicted in FIG. 7E. The child nodes may represent the actions. The child nodes may be successively generated till reaching one or more leaf nodes.

In accordance with the MCTS method, the child nodes may be selected by traversing the knowledge graph using an Upper Confidence Bound for Trees (UCT) function. In an example, the UCT function may be represented as:

$$U C T = \frac{Q ( s , a )}{N ( s , a )} + C \times sqrt ( \frac{ln N ( s )}{N ( s , a )} )$$

wherein, ‘Q(s, a)’ represents a total reward (or value) of applying an action ‘a’ from a state ‘s’, ‘N(s, a)’ represents a number of times the action ‘a’ has been taken from the state ‘s’, ‘N(s)’ represents a total number of times the state ‘s’ has been visited or traversed, and ‘C’ represents a constant that controls exploration-exploitation balance on the GNN transformer model. ‘N(s, a)’ and ‘N(s)’ may be referred to as exploration terms.

The updated node features (e.g., enriched and context-aware information) may impact the UCT function. For example, the updated node features may impact ‘Q(s, a)’, the explorations terms, the exploration-exploitation balance in the UCT function.

Impact on the ‘Q(s, a)’:

The updated node features in the knowledge graph representing the state ‘s’ may provide a richer and accurate understanding of the current state of the knowledge graph by considering the dependencies between the various state attributes (e.g., how increasing compute resources affects network latency and costs). Further, the the updated node features in the knowledge graph representing the state ‘s’ may provide the GNN transformer model with a complete and enhanced view of the current state of the resource, which may result in accurate prediction of the total reward (Q(s,a)).

### Impact on the Exploration Terms:

The exploration terms in the UCT function may balance between exploring new actions and exploiting the actual actions. As the actions are explored and the knowledge graph is expanded, the GNN transformer model may capture enhanced impact of the actions (e.g., how changes in a state attribute affect other state attributes of the resource). Such an improved determination of each state may be used in adjusting how often certain actions are taken. For example, the updated node features may be used in either exploring the actions if the knowledge graph discloses unexplored nodes but with favourable relationships (e.g., indirect advantage of increasing storage on network efficiency) or exploiting the GNN transformer model if the knowledge graph discloses that the values of the actions have consistently to high rewards.

### Impact on the Exploration-Exploitation Balance:

The updated node features may disclose hidden relationships between the state attributes that were not immediately observed from the input data (e.g., how reallocating budget affects compute efficiency through network dependencies). Capturing of such relationships may aid in exploring the actions that may not have been prioritized initially. Further, the policy and value predictions provided by the GNN transformer model may be used to accurately exploit the actions with the high policy and value predictions, since the updated node features capture all the relationships between the state attributes. Thereby, the exploration-exploitation balance may become data-driven, based on insights provided by the updated node features.

In an example, consider a scenario wherein the knowledge graph corresponding to the current state of the resource may include a compute node: CPU utilization=70%, VM count=8, and cost=$1500, a storage node: disk usage=60% and cost=$1000, and a network node: bandwidth utilization=50%, latency=15 ms, and cost=$800. The desired requirement may indicate an action, for example, to increase compute resources by 10%. After applying the action, the node features may be updated as: the compute node: CPU utilization=80%, and cost=$1700, the storage node: disk usage may increase due to a large volume of data being generated after applying the action, and a network node: bandwidth utilization may increase due to high compute load affecting latency. Thereby, the updated node features may disclose that increasing the compute resources may result in additional load on the network, while increasing bandwidth utilization and latency. Based on such insights, a low overall reward for the action may be predicted than initially expected due to a negative impact on the network performance. Therefore, ‘Q(s, a)’ may be reduced for the action, which may ensure that the action may be exploited less in a future unless trade-offs may be mitigated. Further, based on the updated node features, alternative actions may be decided such as, reallocating budget to improve network capacity before increasing the compute resources. Therefore, the exploration terms in the UCT function may aid in exploring different alternative action that may improve an overall performance of the resource. For the applied action (e.g., increasing compute resource), the UCT function may be refined as:

$$U C T = \frac{Q ( s , a )}{N ( s , a )} + C \times sqrt ( \frac{ln N ( s )}{N ( s , a )} )$$

wherein, the reduced ‘Q(s, a)’ may lower a score that may be derived from the UCT function for the action. Therefore, impact of the updated node features on the UCT function may result in enriched state representation of the resource, improved policy and value predictions, improved exploration-exploitation balance, and improved selection of the actions.

Further, the GNN transformer model used for updating the node features may not directly impact the UCT function, however, usage of the GNN transformer model may have a significant impact on how values used in the UCT function are calculated. The updated node features using the GNN transformer model may be informative, as the node features are updated based on determining how each state attribute of the resource impacts or effects other state attributes, which may result in an accurate and complete view of the state of the resource. Further, as the GNN transformer model relies on the knowledge graph of the resource, the updated node features using the GNN transformer model may improve the policy and value predictions. The improved policy and value predictions may directly affect the exploration terms in the UCT function. In addition, the GNN transformer model may use a refined state representation of the resource to predict the probability distribution of the actions. Such prediction may improve exploration or exploitation of the actions, which may impact a count of the exploration terms ‘N(s, a)’ and ‘N(s)’. Therefore, usage of the GNN transformer model may improve exploration of the actions, exploitation of the actions with the high policy and value predictions, and exploration-exploitation balance.

Upon generating the child nodes, at step 612, the iterative strategy engine 210 performs expansion of the knowledge graph to generate the expanded knowledge graph. The iterative strategy engine 210 may select a leaf node(s) from the one or more leaf nodes for expansion. The selected leaf node may represent an expected state of the cloud environment and when expanded, the iterative strategy engine 210 may create additional child nodes from each leaf node. The additional child nodes may correspond to future states of the cloud environment. Further, the additional child nodes may reflect outcome of applying the actions to the nodes representing the current state of the cloud environment. Examples of the actions may include scaling resources, reconfiguring networks, reallocating budges, and/or the like.

For generating the expanded knowledge graph, at the selected leaf node, the iterative strategy engine 210 may select actions to apply to the nodes representing the current state of the resource. Examples of the actions may include:
Increase/Decrease Compute Resources: Adding or removing CPU/GPU instances based on utilization requirements.
Storage Optimization: Increasing storage capacity or switching to more cost-efficient storage solutions.
Network Configuration: Changing bandwidth allocations or rerouting traffic to improve performance and lower costs.
Budget Reallocation: Shifting financial resources between services to maximize cost efficiency.
Task Automation Enhancement: Introducing or enhancing automated workflows to improve operational efficiency.
Security Adjustments: Improving security measures like encryption or access control.

After selecting the actions, the iterative strategy engine 210 may apply the actions on the nodes representing the current state of the resource and accordingly generate the additional child nodes. Each of the additional child nodes may inherit the state of the previous node with updated node features that reflect changes or outcomes of the applied actions. In an example, consider a scenario where the actions including increasing CPU instances by 20% and reducing storage costs by switching to a lower tier on a node representing the current state of the resource (e.g., a node with underutilized CPU resources and moderate storage usage). In such a scenario, an additional child node generated may be a new node with updated CPU utilization and optimized storage costs.

After generating the additional child nodes, the iterative strategy engine 210 may use each of the additional child nodes to update the knowledge graph of the cloud environment to reflect changes in the node features. In an example, updating of the node features after generating the additional child nodes may include:
Compute Resources: After scaling CPU/GPU instances, the node features such as CPU usage, instance count, idle time, and/or the like, may be updated.
Storage: After changing storage capacity or tier, the node features such as storage cost, capacity, and performance metrics may be recalculated.
Network: If bandwidth allocation is changed, the node features such as network latency, transfer costs, and bandwidth usage may be updated.
Budget: A budget reallocation may be reflected in the node while representing a new distribution of cost spend across services.
Task Automation: Changes in automation efficiency (e.g., reducing manual interventions) may be updated in the node features.
Security: Updates in security posture (e.g., enhanced encryption) may be reflected in the node's security efficiency metrics.
Deployment Frequency and Response Time: If actions improve task automation, deployment frequency and average response time may be updated accordingly.

Further, after generating the additional child nodes, the iterative strategy engine 210 may assign a reward or value to each of the additional child nodes based on effectiveness of applied actions. In some examples, the reward may be combination of factors such as, but are not limited to, cost savings, performance improvements, resource efficiency, security gains, compliance with Service Lease Agreements (SLAs). The cost savings may indicate how much the applied actions reduce operational costs. The performance improvements may indicate whether the applied actions enhance performance of the cloud environment (e.g., reduced response time, increased throughput, and/or the like). The resource efficiency may indicate whether the compute resources are being used more efficiently or not (e.g., CPU utilization), The security gain may indicate whether the applied actions improve an overall security posture or not. The compliance with SLAs may indicate whether the applied actions maintain or improve SLA compliance.

Generation of the additional child nodes and updating the node features may result in the expanded knowledge graph. Each of the additional child nodes in the expanded knowledge graph may indicate an updated state of the cloud environment. An exemplary code snippet 700F illustrating generation of the expanded knowledge graph is depicted in FIG. 7F.

At step 616, the iterative strategy engine 210 performs simulation of the actions on the current state of the resource in the expanded knowledge graph and updates the expanded knowledge graph. The iterative strategy engine 210 may apply the selected actions to the nodes in the expanded knowledge graph representing the current state of the cloud environment (e.g., increasing compute resources, optimizing storage, reallocating budget, and/or the like). After simulating the actions, the iterative strategy engine 210 may update the expanded knowledge graph to reflect the impact or outcome on the state attributes of the resource.

At step 618, the iterative strategy engine 210 calculates the actual rewards for the simulated actions. The actual rewards may be associated with cost savings, performance improvements, or resource efficiency. At step 620, the iterative strategy engine calculates the expected long-term rewards based on the actual rewards and the future rewards.

At step 622, the iterative strategy engine 210 performs the backpropagation. For performing the backpropagation, the iterative strategy engine 210 may identify whether the simulation has reached the terminal node.

In some examples, the simulation may reach the terminal node when the desired requirements of the resources are achieved. To illustrate, if the desired requirements include an action to optimize compute resources of the resource while maintaining a pre-defined performance level, the iterative strategy engine 210 may determine that the terminal node is reached when the computer resources achieve desired operational efficiency (e.g., CPU utilization, storage efficiency) and satisfy performance targets (e.g., latency, response time) without violating resource constraints (e.g., budget or security). Thereby, when the simulation reaches the terminal node, the resource may achieve a balance where the operational efficiency improves, and no further actions may result in an improved outcome. In some other examples, the simulation may reach the terminal node when no further actions may be applied from the current state due to constraints like budget exhaustion, maximum resource usage, or limitations on the available state attributes of the resource. To illustrate, the iterative strategy engine 210 may determine that the terminal node is reached, if the resource lacks budget or the resource may not increase allocation of compute resources without exceeding predefined thresholds for compute storage or network resources.

In some other examples, the simulation may reach the terminal node, when the simulation reaches a maximum simulation depth or time horizon defined for the simulations. The maximum simulation depth may indicate a number of decisions or actions (e.g., 10 steps in the simulation) after which the iterative strategy engine 210 may consider the terminal node. To illustrate, after 10 iterations of adjusting allocation of compute resources, the simulation may stop, and a current configuration of the resource may be determined as a terminal state for the simulation.

In some other examples, the simulation may reach the terminal node, when further actions do not lead to significant improvement in the outcome of the simulation (e.g., the resource has reached a strategic deadlock). Such a scenario may occur when all the actions have been explored and none of the actions have further favorable outcomes. To illustrate, the iterative strategy engine 210 may determine that the terminal node is reached, when reallocation of compute resources does not improve efficiency of the resource after simulating the multiple actions.

In some other examples, the simulation may reach the terminal node, when continuing the simulation may violate the resource constraints such as, but are not limited to, security, operational thresholds, and/or the like. To illustrate, the iterative strategy engine 210 may determine that the terminal node is reached, on occurrence of a security breach, or when a performance threshold is violated (e.g., latency exceeds an acceptable level). In such a scenario, the terminal node may be considered as a failure state.

Further, the terminal node may be considered as a win node or a loss node. The win node may be characterized by satisfying or exceeding the resource constraints, such as, but are not limited to, resource optimization, budget efficiency, performance goals or targets, and policy compliance without violating the resource constraints. The loss node may be reached when the resource exhausts the compute resources, exceeds budget limits, experiences performance degradation, experiences security failures, or violates organizational policies. In an example implementation, the GNN transformer model may determine whether the terminal node is the win node or the loss node by estimating the long-term rewards of the actions. Based on the rewards assigned to the win node or the loss node, the child nodes may be selected that lead to terminal nodes that are win nodes.

In an example, the terminal node may be considered as the win node, when utilization of the compute resources is optimal. Utilization of the compute resources may be considered as optimal when the compute resources are allocated in a way that maximizes operational efficiency, performance, or cost savings (e.g., CPU utilization is optimized to satisfy requirements, storage is efficiency used, and network bandwidth is utilized without bottlenecks). In another example, the terminal node may be considered as the win node, when the resource operates within pre-defined budget allocations and costs of the resources are minimized while maintaining or improving performance. In yet another example, the terminal node may be considered as the win node, when the resource satisfies the performance goals such as, reduced latency, increased response time, high task automation, improved security (e.g., latency is reduced below specified threshold (e.g., from 200 ms to 150 ms), or task automation leads to quicker response times and higher efficiency). In yet another example, the terminal node may be considered as the win node, when a balance trade-off is achieved between the multiple goals such as, maintaining high security while ensuring optimal performance and controlled budget (e.g., security efficiency is maintained at a high level (e.g., 85%), while the deployment frequency remains optimal (e.g., weekly deployments without affecting performance)). In yet another example, the terminal node may be considered as the win node, when the resource complies with organizational policies and regulatory requirements, such as maintaining security thresholds or adhering to budget constraints (e.g., no critical security breaches or budget overspend occurs). In yet another example, the terminal node may be considered as the win node, when the resource meets a desired state (e.g., steady operational state) where the further actions may not significantly improve performance, cost, and usage of the compute resources.

In an example, the terminal node may be considered as the loss node, when the resource lacks the compute resources without achieving the performance goals (e.g., CPU resources are fully utilized (e.g., 100%) resulting in slowdowns or inability to meet the performance goals). In another example, the terminal node may be considered as the loss node, when the budget allocation is exceeded, and the resource may no longer operate efficiently due to the budget constraints. In yet another example, the terminal node may be considered as the loss node, when the resource fails to meet the performance goals such as, improving response time, task automation, reducing latency, and/or the like. In yet another example, the terminal node may be considered as the loss node, when the resource experiences a security failure or breach, violating security policies or thresholds (e.g., security efficiency drops below acceptable levels (e.g., less than 70%), resulting in an increased risk of security incidents). In yet another example, the terminal node may be considered as the loss node, when the resource becomes operationally inefficient, leading to wasted resources or poor performance (e.g., the compute resources are over-allocated but not utilized effectively, which may result in increased costs with degraded performance). In yet another example, the terminal node may be considered as the loss node, when resource violates critical organizational policies or regulatory requirements, leading to failure. In yet another example, the terminal node may be considered as the loss node, when key dependencies or bottlenecks remain unresolved, causing the resource to perform poorly or fail to meet the desired requirements (e.g., allocating more compute resources increases network latency, while creating bottlenecks and reducing the overall performance of the resource).

When it has been determined that the terminal node has been reached, the iterative strategy engine 210 may perform the back propagation to propagate the results of the simulation from the terminal node to the nodes of the knowledge graph. Further, for each node (s, a), the iterative strategy engine 210 may update the visit count as:

$$N ( s , a ) ← N ( s , a ) + 1$$

Also, the iterative strategy engine 210 may update the reward as:

$$Q ( s , a ) ← Q ( s , a ) + ( r - Q ( s , a ) ) / N ( s , a )$$

where ‘r’ indicates a reward received from the simulation). An exemplary code snippet 700G illustrating the simulation of the actions, and the backpropagation is described in FIG. 7G.

At step 624, the iterative strategy engine 210 selects the optimal action. The iterative strategy engine 210 may select the optimal action based on the results of previous simulations and expansions of the knowledge graph. After performing multiple simulations and expansions, the iterative strategy engine 210 may compare a value or visit count of each action. The iterative strategy engine 210 may select the action with the highest value (e.g., indicating the highest beneficial outcome) or the highest visit count (e.g., indicating consistent results) as the optimal action. Once the optimal action is selected, the iterative strategy engine 210 may update the state of the resource and the corresponding expanded knowledge graph to reflect new configurations achieved after the selected optimal action has been applied on the expanded knowledge graph of the resource. An exemplary code snippet 700H illustrating selection of the optimal action (e.g., best action node) is depicted in FIG. 7H.

At step 626, the iterative strategy engine 210 checks if the pre-defined criteria (indicating the targets predefined for the simulation or the predefined stability period) have been reached. If the pre-defined criteria have not been reached, the iterative strategy engine 210 iteratively repeats steps 606-626, until the predefined criteria have been reached.

If the pre-defined criteria have been reached, at step 628, the iterative strategy engine 210 generates the training data including state-action-reward-next state (SARS') sequences The reward may indicate an immediate or actual impact, for example, improved performance, cost savings, enhanced security, and/or the like. The next state may indicate a resulting state after applying the optimal action. For example, consider that there are three actions (actions 1-3) configured to be applied on the resource, for example, a cloud environment. An action 1 may indicate adjusting the compute resources. In such a scenario, the actions may indicate increasing the compute resources by 10%, the state may indicate a state change (e.g., compute utilization changes from 70% to 80%) affecting performance and costs, the reward may indicate an improvement in a response time (from 200 ms to 180 ms) with a small cost increase, and the next state may indicate a updated state reflecting new compute resource levels and performance metrics. An action 2 may indicate budget reallocation. In such a scenario, the actions may include reallocating $50,000 to security budget, the state may indicate a state change (e.g. increased security budget with decreased operational budget), the reward may indicate improvement in threat detection efficiency (from 75% to 85%) with reduced funds for other operations, and the next state may indicate updated budget allocation and security metrics. An action 3 may indicate enhancing automation. In such a scenario, the actions may include increasing task automation by 10%, the state may indicate a state change (e.g., automation improvement from 50% to 60%) enhancing operational efficiency, the reward may indicate reduction in an average response time due to increased automation, and the next state may indicate an updated state with improved automation levels and performance metrics.

Therefore, the iterative strategy engine 210 may use integration of the MCTS method along with the GNN transformer model to simulate various actions and results. By iterating through the action selections, expansions, simulations, and rewards, the iterative strategy engine 210 may continuously learn and refine optimization of the actionable strategies, which may aid the user to make informed decisions for improving performance and efficiency of the resource.

Consider an example scenario, wherein a resource may correspond to a cloud environment including state attributes such as, compute resources, task automation, and budget allocation. It is contemplated that the implementations of the present disclosure may be realized with multiple number of state attributes of the cloud environment.

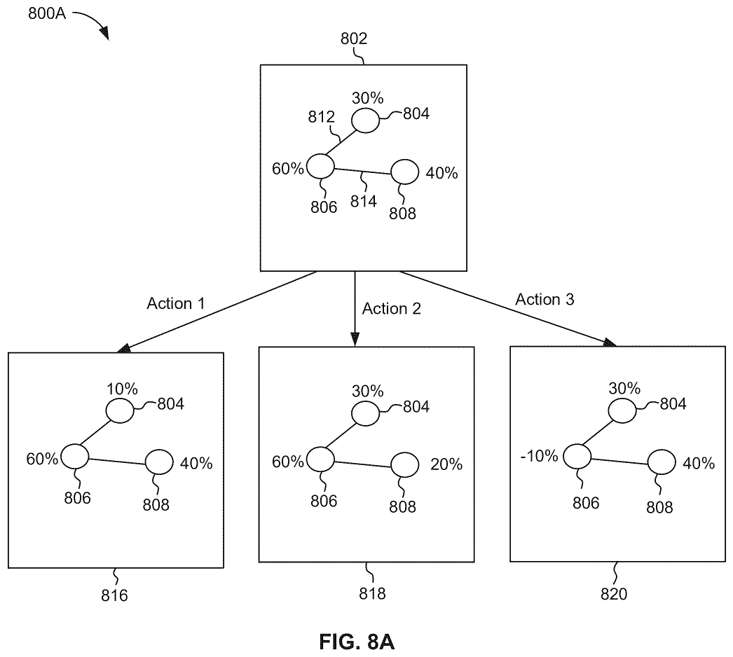

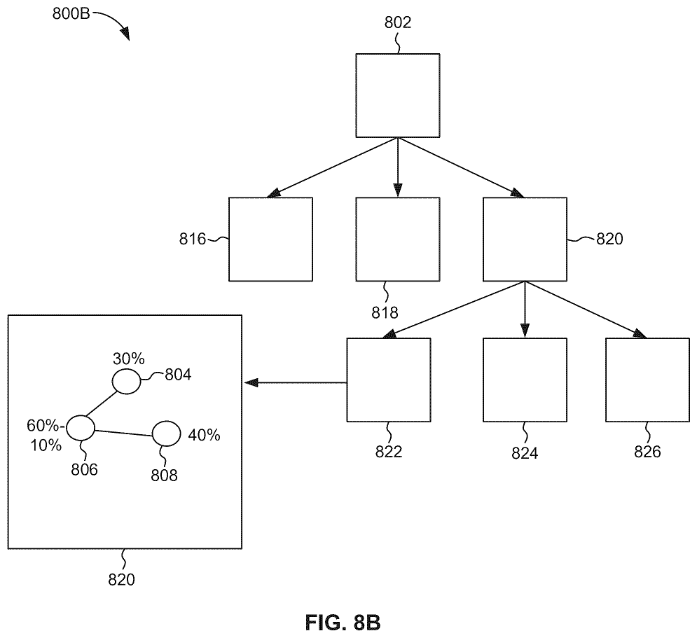

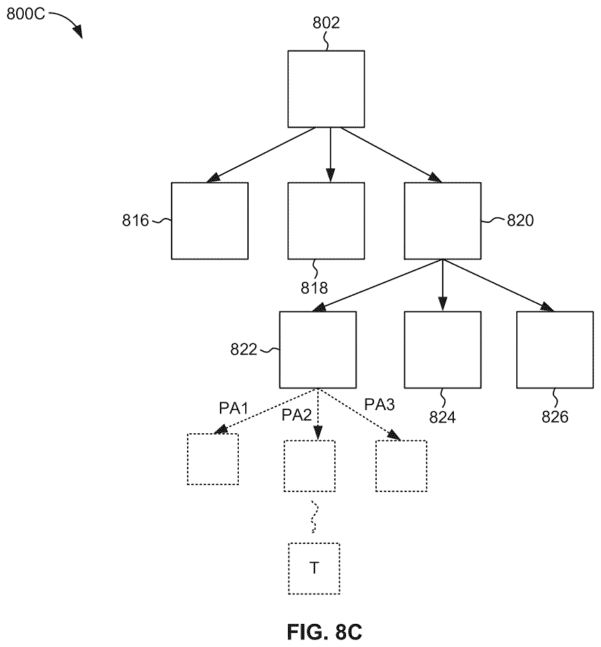

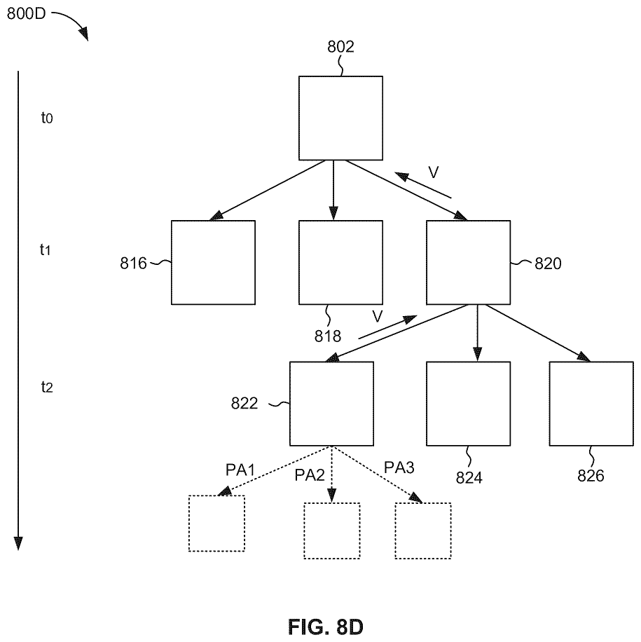

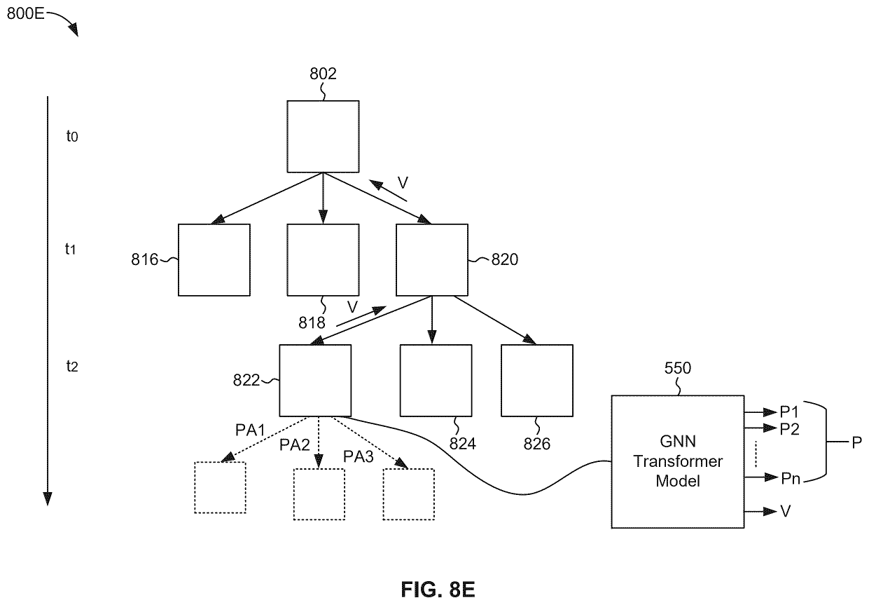

In an execution or selection phase 800A (corresponding to steps 604-610) as depicted in FIG. 8A, the iterative strategy engine 210 generates a knowledge graph 802. The knowledge graph 802 includes a node 804 representing the compute resources (hereinafter referred to as compute node 804), a node 806 representing the budget allocation (hereinafter referred to as budget node 806), and a node 808 representing the task automation (hereinafter referred to as automation node 808). The knowledge graph 802 further includes an edge 812 between the compute node 804 and the budget node 806, and an edge 814 between the budget node 806 and the automation node 808. Node features of the compute node 804 may be updated as CPU utilization=30%. Node features of the budget allocation may be updated as disk usage=60%. Node features of the automation node 808 may be updated as automated tasks=40%.

Further, in the execution or selection phase 800A, the iterative strategy engine 210 uses the MCTS method and the GNN transformer model to traverse the knowledge graph 802 and selects child nodes, for example, a child node 816, a child node 818, and a child node 820. The child nodes 816, 818, and 820 may represent actions 1, 2, and 3, respectively. The actions 1, 2, and 3 may include scaling up the compute resources by 10%, increasing the task automation by 20%, and reallocating the budget to the compute resources by 10%. The actions 1, 2, and 3 may be associated with a probability distribution indicating probabilities of 0.2, 0.1, and 0.6, respectively.

In the expansion phase 800B (corresponding to step 612), as depicted in FIG. 8B, the iterative strategy engine 210 selects the child node 820 as a leaf node. At the leaf node or the child node 820, the iterative strategy engine 210 applies the action 3 (the action with the highest probability among the actions 1 and 2) to the current state of the cloud environment, which results in additional child nodes 822, 824, and 826 for the leaf node or the child node 820. The additional child nodes 822, 824, and 826 represent a future state of the cloud environment. The additional child nodes 822, 824, and 826 may reflect outcome of applying the actions to the current state of the cloud environment, as depicted in FIG. 8B.

In the simulation phase 800C (corresponding to steps 616-620), as depicted in FIG. 8C, the iterative strategy engine 210 simulates the actions from the additional child nodes 822, 824, and 826 till reaching a terminal node (T), following a decision or simulation path. For example, simulation of the action on the additional child node 822 may further result in new child nodes for the additional child node 822 representing future actions such as PA1, PA2, and PA3. Further, a new child node corresponding to any of the actions PA1, PA2, and PA3 with the highest probability may be selected for further simulation. Such a process of simulating the actions may be iterated till reaching the terminal node. The iterative strategy engine 210 assigns the actual and expected long-term rewards (include rewards or losses (V)) for the actions based on results of the simulation.

In the backpropagation phase 800D (corresponding to step 622), as depicted in FIG. 8D, the iterative strategy engine 210 backpropagates results of the actions (e.g., rewards or losses (V)) through the expanded knowledge graph. Further, as depicted in FIG. 8E, the training data such as the state, the actions, the rewards, and the next state (represented by the additional child node 822), provided to the GNN transformer model 550 for predicting the policy and value predictions.

FIG. 9 depicts an exemplary process flow 900 of training the GNN transformer model 550, in accordance with implementations of the present disclosure.

At step 902, the strategy policy training engine 212 receives the training data from the vector database 322. The training data may include the state-action-reward-next state (SARS') sequences.

At step 904, the strategy policy training engine 212 trains the GNN transformer model to generate policy and value predictions based on the training data. The strategy policy training engine 212 may input the training data to the GNN transformer model 550 and receive the policy and value predictions based on processing of the training data using the GNN transformer model 550. Thereby, the trained GNN transformer model 550 may be generated. In some examples, the GNN transformer model 550 may be trained using reinforcement learning methods. After generating the value and network predictions, at step 906, the strategy policy training engine 212 calculates the policy loss and the value loss. The policy loss may measure how well the predicted probabilities match the optimal actions over the time.

At step 908, the strategy policy training engine 212 optimizes the trained GNN transformer model using an optimizer (e.g., Adam) and a learning rate scheduler. Optimizing the GNN transformer model 550 may involve iteratively tuning the parameters or hyperparameters of the GNN transformer model 550 until the policy loss and the value loss have been minimized.

After optimizing the trained GNN transformer model, at step 910, the strategy policy training engine 212 evaluates the trained GNN transformer model based on metrics such as, accuracy, precision, recall, and so on. At step 912, the strategy policy training engine 212 performs checkpointing and version control.

At step 914, the strategy policy training engine 212 checks if storage epoch iterations have been satisfied. If the storage epoch iterations have been satisfied, at step 916, the strategy policy training engine 212 stores the trained and optimized GNN transformer model in the model database 328. If the storage epoch iterations have not been satisfied, the strategy policy training engine 212 selects 918 a next batch of data from the vector database 322 to train and validate the GNN transformer model (by performing steps 902-916).

FIG. 10 depicts an exemplary conceptual architecture of the GNN transformer model 550, in accordance with implementations of the present disclosure. The GNN transformer model 550 includes an input layer 1002, hidden layers 1004, and an output layer 1006. The hidden layers 1004 includes a positional encoder 1008 and a transformer encoder 1010. The output layer 1006 includes a transformer decoder 1012. The transformer encoder 1010 includes a self-attention layer 1010a, a first add & norm layer 1010b, a feed forward layer 1010c, and a second add & norm layer 1010d. The transformer decoder 1012 includes a masked self-attention layer 1012a, a first add & norm layer 1012b, a cross-attention layer 1012c, a second add & norm layer 1012d, a feed forward layer 1012e, a third add & norm layer 1012f, an output linear function 1012g, and a softmax function 1012h.

The input layer 1002 may receive the training data including the state-action-reward-next state (SARS') sequences as an input and convert the training data into input embeddings. The positional encoder 1008 may add temporal dependencies or positional information to the input embeddings. The transformer encoder 808 may capture (e.g., using the self-attention layer 1010a) the dependencies between the state attributes of the resource based on the input embeddings and process and refine (e.g., using the feed-forward layer 1010c) the updated node features of each node in the knowledge graph. The transformer decoder 1012 may handle (e.g., using the masked self-attention layer 1012a) the dependencies within target sequences and link (e.g., using the cross-attention layer 1012c) the updated node features with next state features. Upon linking the updated node features, the transformer decoder 1012 may process (e.g., using the feed forward layer 1012e) the updated node features and output the policy and value predictions. The policy and value predictions may include the probability distribution (e.g., policy predictions) indicating the probabilities of the actions and the rewards (e.g., value predictions) for the actions. The policy and value predictions may guide simulation of the actionable strategies by continuously refining a decision-making process.

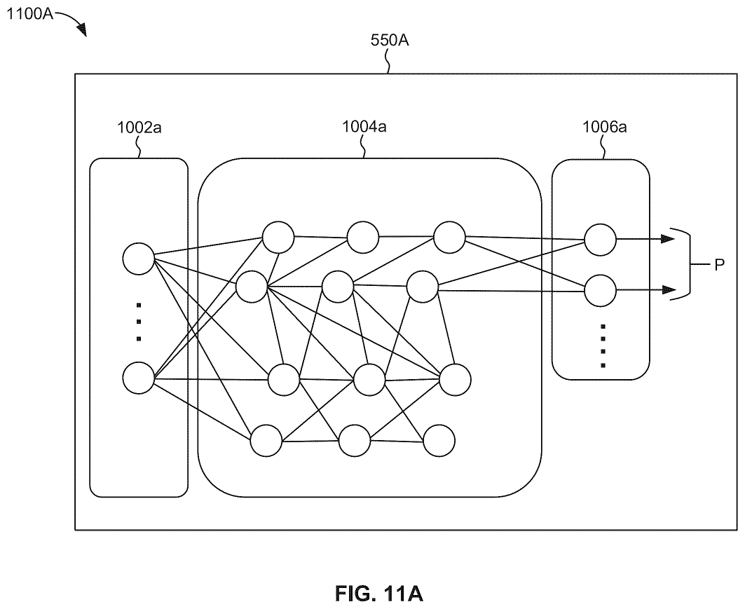

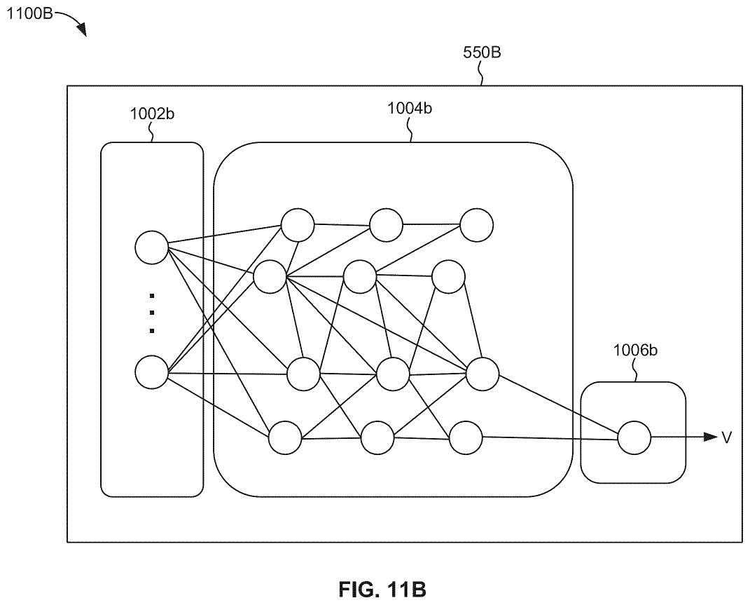

In an example implementation, the GNN transformer model 550 may act as a policy network 550A and a value network 550B for predicting the policy and value predictions, which is described along with FIGS. 11A and 11B.

FIG. 11A depicts an exemplary conceptual architecture 1100A of the policy network 550A, in accordance with implementations of the present disclosure. The policy network 550A may be used for generating the probability distribution across the actions, which may aid in selecting one or more of the actions to be applied. The state of the resource may be inputted to the policy network and the probability distribution of the actions may be outputted by the policy network by capturing relationships between the state attributes of the resource.

The policy network 550A may include an input layer 1002a, hidden layers 1004a, and an output layer 1006a. The input layer 1002a may receive the state of the resource. The state of the resource may capture the current state of the resource including the key attributes and their relationships or dependencies. The hidden layers 1004a may include fully connected layers and activation functions for processing the received state of the resource. The received state of the resource may be processed by learning complex patterns and dependencies between the key attributes of the resource, which may aid in predicting the actions that are favorable for the resource in the given state of the resource. The output layer 1006a may include a fully connected layer with a softmax function. The output layer 1006a may output the probability distribution over the actions based on the processed state of the resource. Each action may be assigned with a probability that reflects a confidence of the policy network 550A in predicting the actions. In some examples, the output layer 1006a may generate raw output scores for the actions and use a softmax function to convert the raw output scores into the probabilities for the actions, while ensuring that all the probabilities of the actions may sum to 1. The probabilities generated for the actions using the policy network 550A may help in selecting the actions to be applied on the current state of the resource, while ensuring the exploration-exploitation balance.

In an implementation, performance of the policy network 550A may be improved over time by training the policy network 550A across multiple iterations through the reinforcement learning. Thereby, the probabilities for the actions may be refined based on outcomes or results of the previous simulations.

FIG. 11B depicts an exemplary conceptual architecture 1100B of the value network 550B, in accordance with implementations of the present disclosure. The value network 550B may be used for predicting the long-term reward (e.g., value predictions) for the actions or a value for the resource. The predicted value may indicate a value of being in a particular state, given the initial conditions of the resource. Such a prediction may be used to identify how valuable the current state of the resource in long execution or simulation path after applying the selected actions. Thereby, the value predictions may aid in evaluating quality of the simulated actions.

The value network 550B includes an input layer 1002b, hidden layers 1004b, and an output layer 1006b. The input layer 1002b may receive the state of the resource. The state of the resource may capture the current state of the resource including the key attributes and their relationships or dependencies as well as the information or messages aggregated from the neighbouring nodes. For example, if the current state of the resource has state attributes such as CPU utilization at 80%, network bandwidth at 70%, and budget at $600,000, then configurations of the state attributes and their interdependencies may form the state, which may be inputted to the input layer 1002b as a feature input. Therefore, the value network 550B may be allowed to use the refined and dependency-aware representation of the state. The hidden layers 1004b may include multiple neural network layers (such as multi-layer perceptron) to process the received state. The output layer 1006b may include a fully connected layer with a single linear output. The output layer 1006b may use the processed state to estimate the expected long-term reward for the current state of the resource. The expected long-term reward may reflect the actual reward (e.g., immediate reward) and the future reward. The actual reward may indicate direct impact of the actions (e.g., performance improvements, cost savings, or the like). The value network may estimate the actual reward by estimating how useful the entire decision path or simulation path while considering potential future actions that may follow the current state of the resource. The future reward may indicate expected impacts or costs associated with continuing along the simulation or decision path for the long term. Therefore, the expected long-term reward estimated by the value network 550B may balance the immediate impacts with the potential future outcomes, which may help in selecting the actions that are not only useful in a short term but also optimize the actionable strategies over the long term. For example, if the state of the resource is highly optimized in terms of resource allocation (e.g., improved performance with minimal budget impact), the value network 550B may output a high long-term reward indicating that the current state of the resource may be useful in the decision path for the long term.

In an example implementation, the value network 550B may trained through a process of reinforcement learning to estimate the expected long-term rewards for the actions by comparing its predictions with the actual outcomes of the previous simulations. The expected long-term rewards for the actions may be used in determining whether the actions performed are the actions to explore further or alternative actions have to prioritized.

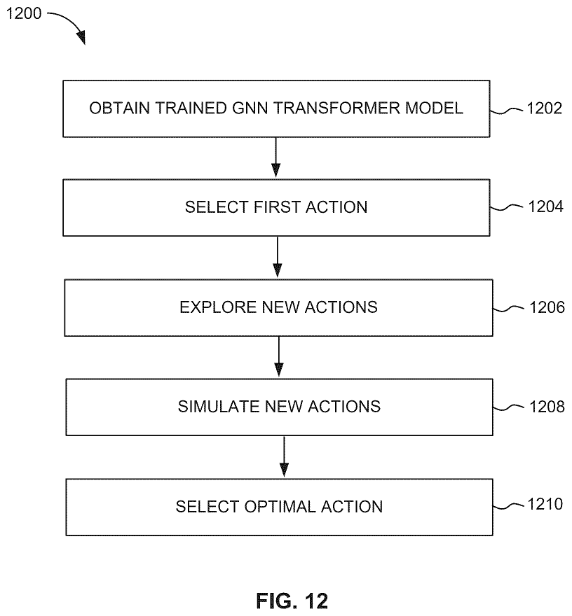

FIG. 12 depicts an example process 1200 of generating the optimal action for managing the resource using the trained GNN transformer model, in accordance with implementations of the present disclosure.

At step 1202, the simulation and analytics engine 214 obtains the trained GNN transformer model from the model database 328. Also, the simulation and analytics engine 214 receives the input data of the resource from the data sources 104a-104n and the desired requirements for managing the resource from the user of the user device 106. In an example, the input data may indicate configurations of the state attributes of the resources in the current state like compute resources=85%, storage=70%, network=75%, and budget=$600,000. The desired requirements may include improving operational efficiency while maintaining security and agility.

At step 1204, the simulation and analytics engine 214 selects a first action. The first action may be selected by processing the current state of the resource using the trained GNN transformer model. For example, consider that the selected first action includes increasing a capacity of the storage by 10%. In such a scenario, the node features of a node corresponding to the storage may be updated from 70% to 80% to improve data handling efficiency. Further, an actual reward may be estimated for the action using the trained GNN transformer model. The actual reward may indicate improvement in data handling, while increase in the budget. Based on the actual reward, a next state of the resource may be predicted as, for example, compute resources=85%, storage=80%, network=75%, and budget=$580,000.

At step 1206, the simulation and analytics engine 214 explores various new actions using the trained GNN transformer model (corresponding to the expansion phase, which is described in detail in conjunction with FIGS. 3 and 6). The simulation and analytics engine 214 may explore new actions such as increasing the compute resources by 5%, reallocating the budget $50,000 to security, or increasing task automation by 5%.

At step 1208, the simulation and analytics engine 214 simulates the new actions and determines results or outcomes of the simulation. The results or outcomes of the simulation of each action may indicate a change in the state (e.g., change in the configurations of the state attributes) of the resource (hereinafter referred to as state change) and an actual reward estimated for the respective action. For example, when a new action 1 corresponding to increasing the compute resources by 5% is simulated, the state change may indicate the change in the configurations of the state attributes, for example, compute resources=85%, storage=80%, network=75%, and budget=$570,000. The actual reward may indicate an improved response time with increase in the budget. For another example, when a new action 2 corresponding to reallocating the budget $50,000 to the security is simulated, the state change may indicate the change in the configurations of the state attributes, for example, compute resources=85%, storage=80%, network=75%, budget=$530,000, and security efficiency=88%. The actual reward may indicate enhanced security with reduction in budget for operations. For yet another example, when a new action 3 corresponding increasing task automation by 5% is simulated, the state change may indicate the change in the configurations of the state attributes, for example, compute resources=85%, storage =80%, network=75%, budget=$580,000, and task automation=70%. The actual reward may indicate improved operational efficiency with increase in automation cost.

At step 1210, the simulation and analytics engine 214 selects an optimal action based on the expected long-term rewards estimated for the actions. The expected long-term rewards may be estimated for the actions based on the actual rewards and the future rewards. For example, the simulation and analytics engine 214 may select the new action 2 corresponding to reallocating the budget $50,000 to the security, as the new action 2 may have the highest reward among the other actions. Upon selecting the optimal action, the simulation and analytics engine 214 may expand the nodes from the updated state, considering actions like optimizing network resources or adjusting deployment frequency. In addition, the simulation and analytics engine 214 may refine the expanded knowledge graph using the trained GNN transformer model to identify the hidden interdependencies and optimize the actions. As would be understood, the optimal action may be selected after performing the multiple simulation. The optimal action may be recommended to the user device 106. The user device 106 may further implement the optimal action to optimize the initial conditions or configurations of the resource.

Therefore, implementation herein select the optimal action by evaluating the various actions, simulating the actions and determining the results of the simulations. Such a selection of the optimal action may aid the user (e.g., an IT admin or an IT leader) in optimizing the configuration of the resource, while improving management of the resource as well as maintaining security, operational efficiency, budget, agility, and/or the like.

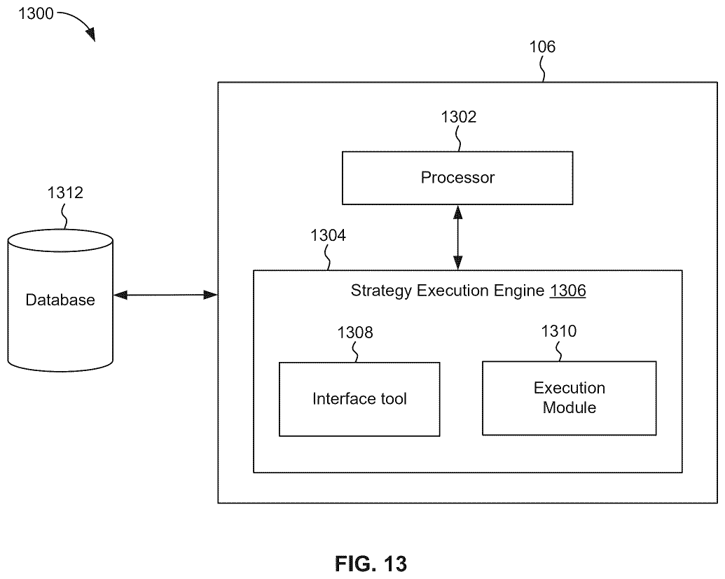

FIG. 13 depicts an exemplary architecture 1300 of the user device 106 for selecting and implementing the actionable strategies for managing the resource, in accordance with implementations of the present disclosure. The user device 106 includes a processor 1302 and a memory 1304 communicably coupled to the processor 1302. The processor 1302 may fetch instructions from the memory 1304 and execute the fetched instructions for performing operations according to the present disclosure (described in detail below). Further, the user device 106 includes a strategy execution engine 1306. The strategy execution engine 1306 may be stored in the memory 1304 and provided as a downloadable library including the instructions. The strategy execution engine 1306 includes an interface tool 1308 and an execution module 1310.

In an example implementation, the processor 1302 may execute the interface tool 1308 to receive the actionable strategies from the system 102. The interface tool 1308 may present the actionable strategies on a user interface of the user device 106. The actionable strategies may include the optimal action to be applied in a resource environment (e.g., cloud environment) for managing the resource and recommendations for managing the resource across the multiple resource constraints or verticals such as operational efficiency, budget or cost, security, agility, and/or the like. The optimal action and the recommendations may suggest a set of configurations and impact of applying the optimal action and/or the other actions.

In an example implementation, the processor 1302 may execute the execution module 1310 to implement the actionable strategies for managing the resource. The execution module 1310 may translate the actionable strategies into specific and actionable tasks that may implemented for managing the resource. Further, the execution module 1310 may be able to interact with different resource providers (cloud service providers) via APIs, Software Development Kits (SDKs), command-line interfaces (CLIs), and/or the like for implementing the actionable strategies. Therefore, the proposed implementation may scale across the multiple resource providers by handling a large volume of data and infrastructure changes with case. In addition, the execution module 1310 may queue and apply the multiple actionable strategies in a batch, which may optimize performance of the resource and reduce downtime.

In some examples, the execution module 1310 may implement the actionable strategies automatically when the actionable strategies include the optimal action(s) associated with low risk or the actionable strategies that have been previously authorized for automation. For example, the action(s) associated with the low risk may include resizing instances, changing storage tiers, updating configurations, optimizing networking rules, and/or any actions that have been performed repetitively or frequently. Automatic implementation of the actionable strategies may enhance speed by reducing latency between recommendation and implementation, which may ensure that actionable strategies are applied quickly for optimizing management of the resource. Also, automatic implementation of the actionable strategies may enhance scalability for large-scale resources, where receiving approvals from the user for every action would be impractical. Therefore, with the automatic implementation of the actionable strategies, overall efficiency of the user device 106 may be improved and the user device 106 may be allowed to optimize the resource without any delay.

In some examples, automatic implementation of the actionable strategies may be guided by predefined rules and constraints set by the entity, which may ensure that only authorized actions are automated. The execution may maintain a detailed log of all the automated actionable strategies in the database 1312 for transparency and compliance.

In some other examples, the execution module 1310 may implement the actionable strategies based on approvals received from the user, when the actionable strategies include the optimal action(s) associated high risk. In some examples, the actions associated with the high risk may include tasks involving core systems, sensitive data, or changes that may have widespread impacts or effects across the entity or any other tasks that have strict regulations indicating necessity of the approvals from the user (e.g., in finance or healthcare industries). Therefore, the user may review the action(s) before implementation by reviewing the actionable strategies and assessing risks associated with the actionable strategies. Further, implementation of the actionable strategies based on the approvals from the user may prevent the user device 106 from applying any actions that may have unintended consequences.

In some examples, implementation of the actionable strategies based on the approvals from the user may be followed in accordance with approval workflows where changes are reviewed and authorized by relevant personnel. If no action has been taken by the user within a pre-defined timeframe, the execution module 1310 may send escalations or alerts for ensuring timely decision-making.

In another example implementation, the execution module 1310 may monitor outcomes of the applied actions in the resource environment and ensure that the outcomes may align with expected results. The execution module 1310 may employ a feedback loop for continuously monitoring metrics related to performance, budget/cost, security, and other Key Performance Indicators after applying the actions. The monitored metrics may ensure that the applied actions may improve management of the resource as intended.

The execution module 1310 may also collect real-time data of the resource to determine the actual impact of the applied actions on the resource and compares with the results of the simulation performed using the iterative strategy engine 210 of the system 102. Based on the determined actual impact, the execution module 1310 may generate feedback for the system 102. The feedback may be used to improve future actionable strategies. If the actionable strategies generated by the system 102 do not produce desired outcome, the system 102 may learn from the feedback and use the feedback for generating accurate actionable strategies in future.

In some examples, based on the real-time data, if the execution module 1310 determines that the implemented actionable strategies negatively impacted the resource or deviate from the expected results, the execution module 1310 may generate an alert for the user or relevant stakeholders of the entity. Further, the execution module 1310 maintains the actionable strategies and a record of impacts or changes occurred in the resource environment due to the implemented actionable strategies in the database 1312.

For example, consider a scenario where the user of the user device 106 wants to decide on an extent to which the compute resources of the resource are scaled up or down. In such a scenario, the user device 106 may receive from the system 102, the actionable strategies including recommendations for optimal compute resource utilization, dynamic service plan adjustment, resource-efficient operational processes, automated resource management, infrastructure readjustment, deployment strategy re-evaluation, security resource allocation, adaptive security measures, and/or the like. The recommendations received for the optimal compute resource utilization may suggest optimal configurations of the resource for cost efficiency, for example, suggest for reducing high-cost compute resource by 5% and increasing efficient instances by 3%, while optimizing cost and maintaining performance. The recommendations received for the dynamic service plan adjustment may suggest switching to flexible service plans that may adapt to changing resource requirements, for example, suggest for switching 10% of workloads to a flexible pricing plan that offers lower rates during off-peak hours, while adapting to usage patterns. The recommendations received for the resource-efficient operational process may suggest adjusting operational workflows to match the new resource scaling for ensuring efficiency, for example, restructuring 20% of data processing tasks to off-peak hours by maximizing use of scaled down resources effectively. The recommendations received for the automated resource management may suggest implementing or enhancing automation in the resource management to streamline operations, for example, suggest for increasing use of AI-driven automation for resource management by 15% while enhancing efficiency with reduced manual intervention. The recommendations received for the infrastructure readjustment may suggest modifications in the infrastructure that support development and operational agility by aligning with the new resource scaling, for example, suggest 7% reduction in the compute resources allocated to non-critical development environments by aligning the compute resources with scaled-down requirements. The recommendations received for the deployment strategy re-evaluation may suggest recommending adjusting deployment strategies to be in line with the new compute resource availability, for example, suggest for modifying deployment cycles to utilize 10% fewer resources by considering critical updates to maintain agile practices. The recommendations received for the security resource allocation may suggest reallocating security resources to ensure critical assets remain protected despite resource scaling changes, for example, suggest for reallocating 5% of security resources from low-risk areas to high-priority assets, while maintaining robust security despite scaled resource changes. Using such actionable strategies, the user device 106 may determine (e.g., automatically or based on inputs received from the user) how much compute resources is provisioned or deprovisioned. Provisioning or deprovisioning may involve increasing compute resources scaling (scaling up) or decreasing compute resources scaling (scaling down). Increasing compute resource scaling may involve allocating or increasing the compute resources to satisfy workload requirements, enhance performance or prepare for anticipated workload increases. Decreasing resource scaling may involve reducing the compute resources to reduce costs, eliminating wastage of the compute resources, or adjusting the compute resources to decreased workload demand.

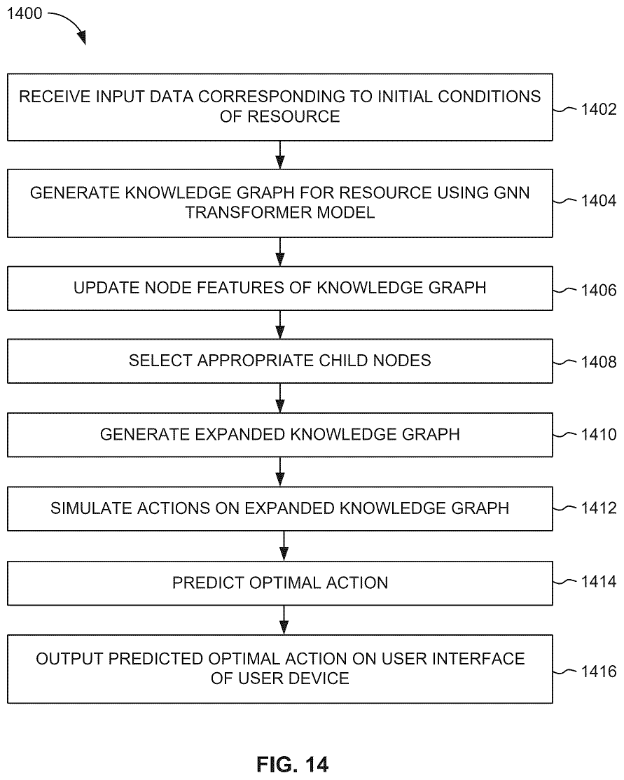

FIG. 14 is flow diagram that presents a method 1400 for generating the optimal action for managing the resource, in accordance with implementations of the present disclosure.

At step 1402, the method 1400 includes receiving, by the processor 202, the input data corresponding to the initial conditions of the resource from the data sources 104a-104n. In some examples, the input data may correspond to initial states, configurations, and desired requirements of the resource. Receiving of the input data is described in detail along with the data collection engine 208 in FIG. 3.

At step 1404, the method 1400 includes generating, by the processor 202, the knowledge graph for the resource using the GNN transformer model based on the received input data. The knowledge graph may correspond to a current state of the resource. The current state of the resource includes the state attributes represented as the nodes and the dependencies between the state attributes represented as the edges. In some examples, to generate the knowledge graph for the resource using the GNN transformer model based on the received input data, the current state of the resource from the data sources 104a-104n may be received. The current state may include the state attributes. The state attributes may include at least one of resources, storage, network, budget, task automation, security efficiency, deployment frequency, and response time. Each of the state attributes may be assigned to each node of the knowledge graph. Thereafter, the dependencies between the state attributes may be determined by correlating each of the state attributes. The dependencies may include at least one of an impact of increasing compute resources on network performance, an effect of reallocating budget on storage capacity, a relationship between a task automation and a security efficiency. Each of the determined dependencies may be assigned to each of the edges of the knowledge graph. Based on the assigned nodes and edges, the knowledge graph for the resource may be generated using the GNN transformer model. Generation of the knowledge graph is described in detail along with FIGS. 3, 6, 7A, 7B, and 8A.

At step 1406, the method 1400 includes updating, by the processor 202, the node features of the generated knowledge graph with the information from neighbouring nodes using the GNN transformer mode. The updated node features may indicate changes in the state attributes and their dependencies. In some examples, to update the node features of the generated knowledge graph, a message is generated at each node by iteratively aggregating information from neighbouring nodes using an aggregation function. The aggregation function may include one of a summation, an averaging, and attention-based weighted aggregation. In some examples, the message may include encoded current state of the node, and the information may include one or more of: edge weights and connection strengths. Based on the generated message, multi-hop dependencies between the nodes in the generated knowledge graph may be captured. Further, based on the generated message and the captured multi-hop dependencies, changes in the state attributes and their dependencies may be determined. The determined changes may be used to iteratively update the node features via a neural network layer of the GNN transformer model until a final node feature for each of the nodes are determined. The final node feature may correspond to a context-aware and dependency-reflective representation of a node state. Updating the node features is described in detail along with FIGS. 3, 6, 7C, and 7D.

At step 1408, the method 1400 includes selecting, by the processor 202, the appropriate child nodes based on the updated node features. Each child node represents at least one action. In some examples, the child nodes may be selected by traversing the knowledge graph using the MCTS method and the GNN transformer model. Based on the updated node features, the Selection of the child nodes is described in detail along with FIGS. 3, 6, 7E, and 8A.

At step 1410, the method 1400 includes generating, by the processor 202, the expanded knowledge graph including the updated node features and the selected child nodes. In some examples, to generate the expanded knowledge graph including the updated node features and the selected child nodes, one or more actions to apply onto the current state of each leaf node may be selected by processing the updated node features. Each leaf node may include the state attributes. For each of the selected one or more actions, a probability distribution may be generated using a soft max function. The selected one or more actions may be applied onto the current state of each leaf node to determine changes to the current state based on the generated probability distribution. Based on the applied one or more actions, additional child nodes for each leaf node may be generated. The additional child nodes may represent future states of the resource. Each of the additional child nodes may indicate an outcome of applying the selected one or more actions to the leaf node. Thereafter, the expanded knowledge graph may be generated. The expanded knowledge graph may include the additional child nodes, the updated node features, and the selected child nodes. Generating the expanded knowledge graph is described in detail along with FIGS. 3, 6, 7F, and 8B.

At step 1412, the method 1400 includes simulating, by the processor 202, the actions on the expanded knowledge graph based on the trained GNN transformer model. In some examples, simulation of the actions may be performed from a selected node to a terminal state based on the trained GNN transformer model. Upon simulating the actions, an update state and update dependencies may be determined within the expanded knowledge graph. Further, a performance of each updated state may be determined to determine a potential impact of selected one or more actions on the resource.

At step 1414, the method 1400 includes predicting, by the processor 202, the optimal action to be performed on the expanded knowledge graph based on the results of simulation. The predicted optimal action may include policy and value predictions. The optimal action may correspond to a set of configurations and a set of attributes required to optimize the initial conditions. In some examples, to predict the optimal action, an expected long-term reward may be estimated for the current state of each node in the expanded knowledge graph based on a probability distribution of each action and a current state of each node. The expected long-term reward may include an actual reward and a future reward. Based on the expected long-term reward, the optimal action to be performed on the expanded knowledge graph may be predicted.

In some examples, the expanded knowledge graph may be updated by performing the predicted optimal action in a simulation environment. The updated knowledge graph may indicate resulting changes in the initial conditions. The updated knowledge graph may include updated node features, updated state attributes and updated dependencies. Further, the updated knowledge graph indicating the resulting changes may be outputted on the user interface of the user device.

At step 1416, the method 1400 includes outputting, by the processor 202, the predicted optimal action to be performed on the user interface of the user device 106. In some examples, to output the predicted optimal action to be performed on the user interface of the user device, the results of simulation may be converted into a plurality of actionable strategies to manage the resource. Based on the actionable strategies, recommendations may be generated to manage the resource. Further, visual representations of the knowledge graph, the results of simulation, and predicted optimal action may be generated.

Implementations of the present disclosure provide technical solutions to multiple technical problems that arise in the context of generating actionable strategies for managing the resource. Implementations of the present disclosure provide a simulation tool that may leverage GNN transformer model based simulations to provide real-time, data driven actionable strategies for managing the resource by enhancing operational efficiency, while reducing budget or cost and enhancing security. Further, using the actionable strategies, the user may decide to perform tasks on the resource, while ensuring a harmonized and efficient resource management approach.

Implementations of the present disclosure further enhance processing speed of the system through parallel simulations and optimize management of the resource by dynamically adjusting the state attributes of the resource based on real-time requirements of the entity. In addition, implementations of the present disclosure further reduce storage and bandwidth requirements by utilizing data augmentation techniques and efficient data management methods.

Implementations of the present disclosure generate the actionable strategies with the following advantages:
Dynamic strategy optimization: Continuous learning and adaptation to changing conditions of the resource may help in generating the efficient, accurate and flexible actionable strategies, which may aid the user in understanding operational trends and demands.
Cross-vertical integration: Implementations of the present disclosure may ensure that the generated actionable strategies are harmonized across the multiple verticals of IT infrastructure such as finance, operations, agility, and security.
Cost and Resource efficiency: Optimizing actionable strategies for managing the resources may improve cost associated with management of the resource and performance of the resource.
Enhanced Security: The actionable strategies may include proactive threat management and adaptive security measures, which may improve the overall security of the resource.
Data-driven insights: The actionable strategies may include deep, actionable insights that enhance strategic planning and operational efficiency of the resource.

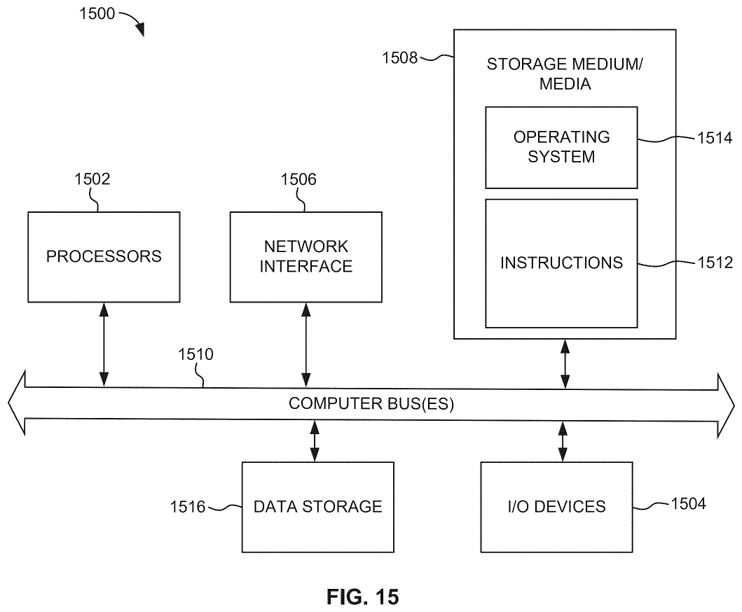

FIG. 15 depicts a computer system 1500 that may be used to implement the method 1400. More particularly, computing machines such as desktops, laptops, smartphones, tablets, and wearables which may be used for generation of the optimal action for managing the resource. The computer system 1500 may include additional components not shown and that some of the process components described may be removed and/or modified. In another example, the computer system 1500 may be deployed on external-cloud platforms such as cloud, internal corporate cloud computing clusters, organizational computing resources, and/or the like.

The computer system 1500 includes processor(s) 1502, such as a central processing unit, ASIC or another type of processing circuit, input/output devices 1504, such as a display, mouse keyboard, and/or the like, a network interface 1506, such as a Local Area Network (LAN), a wireless 802.11x LAN, a 3G or 4G mobile WAN or a WiMax WAN, and a computer-readable medium 1508. Each of these components may be operatively coupled to a bus 1510. The computer-readable medium 1508 may be any suitable medium that participates in providing instructions to the processor(s) 1502 for execution. For example, the computer-readable medium 1508 may be non-transitory or non-volatile medium, such as a magnetic disk or solid-state non-volatile memory or volatile medium such as RAM. The instructions or modules stored on the computer-readable medium 1808 may include machine-readable instructions 1512 executed by the processor(s) 1502 that cause the processor(s) 1502 to perform the method 1400.

The computing system 1500 may be implemented as software stored on a non-transitory processor-readable medium and executed by the processor(s) 1502. For example, the computer-readable medium 1508 may store an operating system 1514, such as MAC OS, MS WINDOWS, UNIX, or LINUX, and code, for the computing system 1500. The operating system 1514 may be multi-user, multiprocessing, multitasking, multithreading, real-time, and the like. For example, during runtime, the operating system 1514 is running and the code for the computing system 1500 is executed by the processor(s) 1502.

The computer system 1500 may include a data storage 1516, which may include non-volatile data storage. The data storage 1516 stores any data used or generated by the computer system 1500.

The network interface 1506 connects the computer system 1500 to internal systems for example, via a LAN. Also, the network interface 1506 may connect the computer system 1500 to the Internet. For example, the computer system 1500 may connect to web browsers and other external applications and systems via the network interface 1506.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer will also include or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 1802 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A system comprising:
a processor; and
a memory communicably coupled to the processor, wherein the memory comprises processor-executable instructions which, when executed by the processor, cause the processor to:
receive input data corresponding to a plurality of initial conditions of a resource from a plurality of data sources, wherein the input data corresponds to initial states, configurations, and desired requirements of the resource;
generate a knowledge graph for the resource using a Graph Neural Network (GNN) transformer model based on the received input data, wherein the knowledge graph corresponds to a current state of the resource, wherein the current state of the resource comprises a plurality of state attributes represented as nodes, and dependencies between the plurality of state attributes represented as edges;
update node features of the generated knowledge graph with information from neighbouring nodes using the GNN transformer model, wherein the updated node features indicate changes in the plurality of state attributes and their dependencies;
select appropriate child nodes based on the updated node features, wherein each child node represents at least one action;
generate an expanded knowledge graph comprising the updated node features and the selected child nodes;
simulate the actions on the expanded knowledge graph based on a trained GNN transformer model;
predict an optimal action to be performed on the expanded knowledge graph based on the results of simulation, wherein the predicted optimal action comprises policy and value predictions, and wherein the optimal action corresponds to a set of configurations and a set of attributes required to optimize the plurality of initial conditions; and
output the predicted optimal action to be performed on a user interface of a user device.

2. The system of claim 1, wherein the processor is further configured to:
update the expanded knowledge graph by performing the predicted optimal action in a simulation environment, wherein the updated knowledge graph indicates resulting changes in the plurality of initial conditions and wherein the updated knowledge graph comprises updated node features, updated plurality of state attributes and updated dependencies; and
output the updated knowledge graph indicating the resulting changes on the user interface of the user device.

3. The system of claim 1, wherein to generate the knowledge graph for the resource using the GNN transformer model based on the received input data, the processor is configured to:
receive the current state of the resource from the plurality of data sources, wherein the current state comprises the plurality of state attributes, and wherein the plurality of state attributes comprises at least one of resources, storage, network, budget, task automation, security efficiency, deployment frequency, and response time;
assign each of the plurality of state attributes to each node of the knowledge graph;
determine dependencies between the plurality of state attributes by correlating each of the plurality of state attributes, wherein the dependencies comprise at least one of an impact of increasing compute resources on network performance, an effect of reallocating budget on storage capacity, a relationship between a task automation and a security efficiency; and
assign each of the determined dependencies to each of the edges of the knowledge graph; and
generate the knowledge graph for the resource using the GNN transformer model based on the assigned nodes and the edges.

4. The system of claim 1, wherein to update the node features of the generated knowledge graph with information from neighbouring nodes using the GNN transformer model, the processor is configured to:
generate a message at each node by iteratively aggregating information from neighbouring nodes using an aggregation function, wherein the aggregation function comprises one of a summation, an averaging, and attention-based weighted aggregation and wherein the message comprises encoded current state of the node, and the information comprises at least one of edge weights and connection strengths;
capture multi-hop dependencies between the nodes in the generated knowledge graph based on the generated message;
determine changes in the plurality of state attributes and their dependencies based on the generated message and the captured multi-hop dependencies; and
iteratively update node features using the determined changes via a neural network layer until a final node feature for each of the nodes are determined, wherein the final node feature corresponds to a context-aware and dependency-reflective representation of a node state.

5. The system of claim 1, wherein to generate the expanded knowledge graph comprising the updated node features and the selected child nodes, the processor is configured to:
select at least one action to apply onto the current state of each leaf node by processing the updated node features, wherein each leaf node comprise the plurality of state attributes;
generate a probability distribution for each of the selected at least one action by using a soft max function;
apply the selected at least one action onto the current state of each leaf node to determine changes to the current state based on the generated probability distribution;
generate additional child nodes for each leaf node based on the selected at least one action, wherein the additional child nodes represent future states of the resource, and wherein each of the additional child nodes indicates an outcome of applying the selected at least one action to the leaf node; and
generate the expanded knowledge graph comprising the additional child nodes, the updated node features, and the selected child nodes.

6. The system of claim 1, wherein to simulate the actions on the expanded knowledge graph based on the trained GNN transformer model, the processor is configured to:
perform simulation of the actions from a selected node to a terminal state based on the trained GNN transformer model;
determine an update state and update dependencies within the expanded knowledge graph upon simulating the at least one action; and
determine a performance of each updated state to determine a potential impact of selected at least one action on the resource.

7. The system of claim 1, wherein to predict the optimal action to be performed on the expanded knowledge graph based on the results of simulation, the processor is configured to:
estimate an expected long-term reward for the current state of each node in the expanded knowledge graph based on a probability distribution of each action and a current state of each node, wherein the expected long-term reward comprises an actual reward and a future reward; and
predict the optimal action to be performed on the expanded knowledge graph based on the expected long-term reward.

8. The system of claim 1, wherein the processor is further configured to:
determine a difference between predicted actions and actual actions executed during simulations;
determine a gap between predicted rewards and actual rewards; and
refine the policy and value predictions indicating the optimal action and associated rewards.

9. The system of claim 1, wherein to output the predicted optimal action to be performed on the user interface of the user device, the processor is configured to:
convert the results of simulations into a plurality of actionable strategies to manage the resource;
generate a plurality of recommendations to manage the resource based on the actionable strategies; and
generate visual representations of the knowledge graph, the results of simulation, and predicted optimal action.

10. A method comprising:
receiving, by a processor, input data corresponding to a plurality of initial conditions of a resource from a plurality of data sources, wherein the input data corresponds to initial states, configurations, and desired requirements of the resource;
generating, by the processor, a knowledge graph for the resource using a Graph Neural Network (GNN) transformer model based on the received input data, wherein the knowledge graph corresponds to a current state of the resource, wherein the current state of the resource comprises a plurality of state attributes represented as nodes, and dependencies between the plurality of state attributes represented as edges;
updating, by the processor, node features of the generated knowledge graph with information from neighbouring nodes using the GNN transformer model, wherein the updated node features indicate changes in the plurality of state attributes and their dependencies;
selecting, by the processor, appropriate child nodes based on updated node features, wherein each child node represents at least one action;
generating, by the processor, an expanded knowledge graph comprising the updated node features and the selected child nodes;
simulating, by the processor, actions on the expanded knowledge graph based on a trained GNN transformer model;
predicting, by the processor, an optimal action to be performed on the expanded knowledge graph based on results of the simulation, wherein the predicted optimal action comprises policy and value predictions, and wherein the optimal action corresponds to a set of configurations and a set of attributes required to optimize the plurality of initial conditions; and
outputting, by the processor, the predicted optimal action to be performed on a user interface of a user device.

11. The method of claim 10, further comprising:
updating, by the processor, the expanded knowledge graph by performing the predicted optimal action in a simulation environment, wherein the updated knowledge graph indicates resulting changes in the plurality of initial conditions and wherein the updated knowledge graph comprises updated node features, updated plurality of state attributes and updated dependencies; and
outputting, by the processor, the updated knowledge graph indicating the resulting changes on the user interface of the user device.

12. The method of claim 10, wherein generating the knowledge graph for the resource using the GNN transformer model based on the received input data comprises:
receiving, by the processor, the current state of the resource from the plurality of data sources, wherein the current state comprises the plurality of state attributes, and wherein the plurality of state attributes comprise at least one of resources, storage, network, budget, task automation, security efficiency, deployment frequency, and response time;
assigning, by the processor, each of the plurality of state attributes to each node of the knowledge graph;
determining, by the processor, dependencies between the plurality of state attributes by correlating each of the plurality of state attributes, wherein the dependencies comprise at least one of an impact of increasing compute resources on network performance, an effect of reallocating budget on storage capacity, a relationship between a task automation and a security efficiency;
assigning, by the processor, each of the determined dependencies to each of the edges of the knowledge graph; and
generating, by the processor, the knowledge graph for the resource using the GNN transformer model based on the assigned nodes and the edges.

13. The method of claim 10, wherein updating the node features of the generated knowledge graph with information from neighbouring nodes using the GNN transformer model comprises:
generating, by the processor, a message at each node by iteratively aggregating information from neighboring nodes using an aggregation function, wherein the aggregation function comprises one of a summation, an averaging, an and attention-based weighted aggregation and wherein the message comprises encoded current state of the node, and the information comprises at least one of edge weights and connection strengths;
capturing, by the processor, multi-hop dependencies between the nodes in the generated knowledge graph based on the generated message;
determining, by the processor, changes in the plurality of state attributes and their dependencies based on the generated message and the captured multi-hop dependencies; and
iteratively updating, by the processor, node features using the determined changes via a neural network layer until a final node feature for each of the nodes are determined, wherein the final node feature corresponds to a context-aware and dependency-reflective representation of a node state.

14. The method of claim 10, wherein generating the expanded knowledge graph comprising the updated node features and the selected child nodes comprises:
selecting, by the processor, at least one action to apply onto the current state of each leaf node by processing the updated node features, wherein each leaf node comprises the plurality of state attributes;
generating, by the processor, a probability distribution for each of the selected at least one action by using a soft max function;
applying, by the processor, the selected at least one action onto the current state of each leaf node to determine changes to the current state based on the generated probability distribution;
generating, by the processor, additional child nodes for each leaf node based on the selected at least one action, wherein the additional child nodes represent future states of the resource, and wherein each of the additional child nodes indicate an outcome of applying the selected at least one action to the leaf node; and
generating, by the processor, the expanded knowledge graph comprising the additional child nodes, the updated node features and the selected child nodes.

15. The method of claim 10, wherein simulating the actions on the expanded knowledge graph based on the trained GNN transformer model comprises:
performing, by the processor, simulation of the actions from a selected node to a terminal state based on the trained GNN transformer model;
determining, by the processor, an update state and update dependencies within the expanded knowledge graph upon simulating the at least one action; and
determining, by the processor, a performance of each updated state to determine a potential impact of selected at least one action on the resource.

16. The method of claim 10, wherein predicting the optimal action to be performed on the expanded knowledge graph based on the results of simulation comprises:
estimating, by the processor, an expected long-term reward for the current state of each node in the expanded knowledge graph based on a probability distribution of each action and current state of each node, wherein the expected long-term reward comprises an actual reward and a future reward; and
predicting, by the processor, the optimal action to be performed on the expanded knowledge graph based on the expected long-term reward.

17. The method of claim 10, further comprising:
determining, by the processor, difference between predicted actions and actual actions executed during simulations;
determining, by the processor, a gap between predicted rewards and actual rewards; and
refining, by the processor, the policy and value predictions indicating the optimal action and associated rewards.

18. The method of claim 10, wherein outputting the predicted optimal action to be performed the user interface of the user device comprises:
converting, by the processor, the results of simulations into a plurality of actionable strategies to manage the resource;
generating, by the processor, a plurality of recommendations to manage the resource based on the actionable strategies; and
generating, by the processor, visual representations of the knowledge graph, the results of simulation, predicted optimal action.

19. A non-transitory computer readable medium comprising a processor-executable instructions that cause a processor to:
receive input data corresponding to a plurality of initial conditions of a resource from a plurality of data sources, wherein the input data corresponds to initial states, configurations, and desired requirements of the resource;
generate a knowledge graph for the resource using a Graph Neural Network (GNN) transformer model based on the received input data, wherein the knowledge graph corresponds to a current state of the resource, wherein the current state of the resource comprises a plurality of state attributes represented as nodes, and dependencies between the plurality of state attributes represented as edges;
update node features of the generated knowledge graph with information from neighbouring nodes using the GNN, wherein the updated node features indicate changes in the plurality of state attributes and their dependencies;
select appropriate child nodes based on updated node features, wherein each child node represents at least one action;
generate an expanded knowledge graph comprising the updated node features and the selected child nodes;
simulate actions on the expanded knowledge graph based on a trained GNN transformer model;
predict an optimal action to be performed on the expanded knowledge graph based on the results of simulation, wherein the predicted optimal action comprises policy and value predictions, and wherein the optimal action corresponds to a set of configurations and a set of attributes required to optimize the plurality of initial conditions; and
output the predicted optimal action to be performed a user interface of a user device.

20. The non-transitory computer readable medium of claim 19, wherein the processor-executable instructions cause the processor to:
update the expanded knowledge graph by performing the predicted optimal action in a simulation environment, wherein the updated knowledge graph indicates resulting changes in the plurality of initial conditions and wherein the updated knowledge graph comprises updated node features, updated plurality of state attributes and updated dependencies; and
output the updated knowledge graph indicating the resulting changes on the user interface of the user device.
